(19) United States
(12) Patent Application Publication
(10) Pub. No.: US 2022/0055873 A1
(43) Pub. Date: Feb. 24, 2022

(54) ROTATING LIFTING BAIL AND METHODS THEREOF

(71) Applicant: Black Diamond Oilfield Rentals LLC, Houston, TX (US)

(72) Inventors: Christopher M. Biggerstaff, Houston, TX (US); Don A. Comeaux, Houston, TX (US); Charles G. Kibbe, New Iberia, LA (US); Ross J. Robin, New Iberia, LA (US)

(73) Assignee: Black Diamond Oilfield Rentals LLC, Houston, TX (US)

(21) Appl. No.: 17/400,056

(22) Filed: Aug. 11, 2021

Related U.S. Application Data
(60) Provisional application No. 63/067,063, filed on Aug. 18, 2020.

(51) Int. Cl. B66C 15/00; B66C 1/66; E21B 19/06

(52) U.S. Cl. CPC B66C 15/00; E21B 19/06; B66C 1/66

(57) ABSTRACT

A rotating lifting bail comprising: a bail, a threaded connector comprising a threaded connection, a rotating mandrel, a housing, wherein the bail is attached to the housing via a connector, a thrust bearing, wherein the thrust bearing is disposed between the rotating mandrel and the housing, and a wherein the threaded connector is attached to the rotating mandrel via a jam bolt. Methods of using the rotating lifting bail are also disclosed.

### PRIOR RELATED APPLICATIONS

This application claims benefit of U.S. Provisional Patent Application Ser. No. 63/067,063 entitled “Rotating Lifting Bail,” filed on Aug. 18, 2020, which is hereby incorporated by reference, for any and all purposes.

### FEDERALLY SPONSORED RESEARCH STATEMENT

Not Applicable (“N/A”)

### REFERENCE TO MICROFICHE APPENDIX

N/A

### FIELD OF INVENTION

The present invention relates generally to a lifting bail and methods thereof and, more particularly, to an improved rotating lifting bail and methods thereof.

### BACKGROUND OF THE INVENTION

A standard lifting bail comprises a bail (i.e., loop) 102 at an upper end and a threaded connection (e.g., box connection, pin connection) at a lower end of the standard lifting bail.

The standard lifting bail is typically made from a single piece of material. It is either machined from a single piece of bar stock, forging or casting. Due to their rigid, unitary structure, the bail (i.e., loop) and the threaded connection of the standard lifting bail cannot rotate with respect to each other.

The drilling tools that are lifted with lifting bails often need to be made-up with (i.e., screwed into) a second component. The second component is often unable to rotate. This requires rotating the component being lifted by the standard lifting bail.

As a result, standard lifting bails impart a twist into hoisting cables (i.e., wire rope) while making up the standard lifting bail with the second component. This twisting can damage the hoisting cables due to being over-wound or under-wound, causing premature wear and tear on the hoisting cable. The premature wear and tear on the hoisting cable can cause premature failure, resulting in a safety hazard for personnel on the drilling rig floor.

To avoid potential premature failure, the useable life of the hoisting cable is often shortened.

Thus, an improved rotating lifting bail is needed to eliminate these problems.

### SUMMARY OF THE INVENTION

In an embodiment, a rotating lifting bail comprises: a bail; a threaded connector comprising a threaded connection; a rotating mandrel; a housing, wherein the bail is attached to the housing via a connector; a thrust bearing, wherein the thrust bearing is disposed between the rotating mandrel and the housing; and wherein the threaded connector is attached to the rotating mandrel via a jam bolt.

In an embodiment, the rotating lifting bail further comprises a friction material, wherein the friction material is disposed between the bail and the rotating mandrel.

In an embodiment, the rotating lifting bail further comprises a spring, wherein the spring is disposed between the thrust bearing and the rotating mandrel.

In an embodiment, the rotating lifting bail further comprises: a friction material, wherein the friction material is disposed between the bail and the rotating mandrel; and a spring, wherein the spring is disposed between the thrust bearing and the rotating mandrel.

In an embodiment, the threaded connector comprises a tapered shaft. In an embodiment, the rotating mandrel comprises a tapered bore. In an embodiment, at least a portion of the tapered shaft is disposed with at least a portion of the tapered bore.

In an embodiment, the rotating lifting bail of further comprises a gap between the bail and the friction material when an adequate axial lifting load is applied to the rotating lifting bail.

In an embodiment, the rotating lifting bail further comprises a gap between the bail and the friction material when an adequate axial lifting load is applied to the rotating lifting bail.

In an embodiment, the friction material is under spring pressure until an adequate axial lifting load is applied to the rotating lifting bail.

In an embodiment, the threaded connector is an interchangeable connection.

In an embodiment, the housing comprises a plurality hinge pins. In an embodiment, the bail comprises a plurality of openings that match the plurality of hinge pins. In an embodiment, the bail is attached to the housing via the plurality of hinge pins.

In an embodiment, the rotating lifting bail is made from one or more aluminum alloys, cobalt alloys, copper alloys, low allow steel, stainless steel, super alloys, titanium alloys, and combinations and variations thereof. In an embodiment, the rotating lifting bail is made from one or more of low alloy steels, stainless steels, and combinations and variations thereof

In an embodiment, the rotating lifting bail is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof. In an embodiment, the rotating lifting bail is connected to one or more of drill collars, drill pipe, heavy weight drill pipe, pup joints, UCTG casings, UCTG tubing, and combinations and variations thereof. In an embodiment, the rotating lifting bail is connected to one or more of UCTG casing, UCTG tubing, and combinations and variations thereof.

In an embodiment, a rotating lifting bail comprises: a bail; a threaded connector comprising a threaded connection; a rotating mandrel; a housing, wherein the bail is attached to the housing via a connector; a housing castle ring, wherein the housing castle ring is disposed between the bail and the housing; a mandrel castle ring, wherein the mandrel castle ring is disposed between the bail and the rotating mandrel and wherein the housing castle ring and the mandrel castle ring have interlocking teeth; a thrust bearing, wherein the thrust bearing is disposed between the rotating mandrel and the housing; and wherein the threaded connector is attached to the rotating mandrel via a jam bolt.

In an embodiment, the rotating lifting bail further comprises a spring, wherein the spring is disposed between the thrust bearing and the rotating mandrel.

In an embodiment, the threaded connector comprises a tapered shaft. In an embodiment, the rotating mandrel comprises a tapered bore. In an embodiment, at least a portion of the tapered shaft is disposed with at least a portion of the tapered bore.

In an embodiment, the interlocking teeth are selected from the group consisting of a square castellation, a tapered castellation, a rounded castellation, and combinations thereof. In an embodiment, the interlocking teeth are a square castellation. In an embodiment, the interlocking teeth are a tapered castellation. In an embodiment, the interlocking teeth are a rounded castellation.

In an embodiment, the rotating lifting bail further comprises a gap between the bail and the mandrel castle ring when an adequate axial lifting load is applied to the rotating lifting bail.

In an embodiment, the housing castle ring and the mandrel castle ring are under spring pressure until an adequate axial lifting load is applied to the rotating lifting bail.

In an embodiment, the interlocking teeth are under spring pressure until an adequate axial lifting load is applied to the rotating lifting bail.

In an embodiment, the threaded connector is an interchangeable connection.

In an embodiment, the housing comprises a plurality hinge pins. In an embodiment, the bail comprises a plurality of openings that match the plurality of hinge pins. In an embodiment, the bail is attached to the housing via the plurality of hinge pins.

In an embodiment, the rotating lifting bail is made from one or more aluminum alloys, cobalt alloys, copper alloys, low allow steel, stainless steel, super alloys, titanium alloys, and combinations and variations thereof. In an embodiment, the rotating lifting bail is made from one or more of low alloy steels, stainless steels, and combinations and variations thereof

In an embodiment, the rotating lifting bail is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof. In an embodiment, the rotating lifting bail is connected to one or more of drill collars, drill pipe, heavy weight drill pipe, pup joints, UCTG casings, UCTG tubing, and combinations and variations thereof. In an embodiment, the rotating lifting bail is connected to one or more of UCTG casing, UCTG tubing, and combinations and variations thereof.

In an embodiment, a rotating lifting bail comprises: a bail; a threaded connector comprising a threaded connection; a rotating mandrel; a locking plate comprising a bore and a lock wherein the locking plate is movably attached to the bail via a connector; a thrust bearing, wherein the thrust bearing is disposed between the rotating mandrel and the bail; and wherein the threaded connector is attached to the rotating mandrel via a jam bolt.

In an embodiment, the threaded connector comprises a tapered shaft. In an embodiment, the rotating mandrel comprises a tapered bore. In an embodiment, at least a portion of the tapered shaft is disposed with at least a portion of the tapered bore.

In an embodiment, the lock is selected from the group consisting of a wrench-style lock on the locking plate, a two-flat slot-style lock on the locking plate that matches machined surfaces on the rotating mandrel, a hexagonal-style lock on the locking plate that matches machined surfaces on the rotating mandrel, a tab-style lock on the locking plate that matches machined surfaces on the rotating mandrel, and combinations thereof In an embodiment, the lock is a wrench-style lock. In an embodiment, the lock is a two-flat slot-style lock. In an embodiment, the lock is a hexagonal-style lock. In an embodiment, the lock is a tab-style lock.

In an embodiment, the rotating lifting bail further comprises a detent attached to a bottom surface of the bail, wherein the detent is disposed between the bail and the locking plate.

In an embodiment, the threaded connector is an interchangeable connection.

In an embodiment, the housing comprises a plurality hinge pins. In an embodiment, the bail comprises a plurality of openings that match the plurality of hinge pins. In an embodiment, the bail is attached to the housing via the plurality of hinge pins.

In an embodiment, the rotating lifting bail is made from one or more aluminum alloys, cobalt alloys, copper alloys, low allow steel, stainless steel, super alloys, titanium alloys, and combinations and variations thereof. In an embodiment, the rotating lifting bail is made from one or more of low alloy steels, stainless steels, and combinations and variations thereof.

In an embodiment, the rotating lifting bail is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof. In an embodiment, the rotating lifting bail is connected to one or more of drill collars, drill pipe, heavy weight drill pipe, pup joints, UCTG casings, UCTG tubing, and combinations and variations thereof. In an embodiment, the rotating lifting bail is connected to one or more of UCTG casing, UCTG tubing, and combinations and variations thereof.

In an embodiment, a method of using a rotating lifting bail comprises: (a) providing the rotating lifting bail as described herein; (b) connecting the threaded connection of the rotating lifting bail to a drilling tool to be lifted; (c) optionally, allowing the rotating mandrel in the rotating lifting bail to rotate; and (d) optionally, allowing the bail in the rotating lifting bail to hinge.

In an embodiment, the method further comprises: (e) lifting the drilling tool.

In an embodiment, the rotating lifting bail is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof. In an embodiment, the rotating lifting bail is connected to one or more of drill collars, drill pipe, heavy weight drill pipe, pup joints, UCTG casings, UCTG tubing, and combinations and variations thereof. In an embodiment, the rotating lifting bail is connected to one or more of UCTG casing, UCTG tubing, and combinations and variations thereof.

In an embodiment, a method of using a rotating lifting bail having an interchangeable threaded connection comprises: (a) providing a rotating lifting bail as described herein, wherein the threaded connector is the interchangeable threaded connection; (b) inserting the tapered shaft into the rotating mandrel; (c) attaching the tapered shaft to the rotating mandrel via the jam bolt; and (d) optionally, locking the rotating mandrel to the tapered shaft with a lock.

In an embodiment, the lock comprises a keyway in the tapered shaft and a key disposed through the rotating mandrel into the keyway in the tapered shaft.

In an embodiment, the method further comprises: (e) optionally, unlocking the rotating mandrel from the tapered shaft with the lock; (f) connecting the interchangeable threaded connection to a drilling tool to be lifted; and (g) lifting the drilling tool.

In an embodiment, the interchangeable threaded connection is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof. In an embodiment, the interchangeable threaded connection is connected to one or more of drill collars, drill pipe, heavy weight drill pipe, pup joints, UCTG casing, UCTG tubing, and combinations and variations thereof. In an embodiment, the rotating lifting bail is connected to one or more of UCTG casing, UCTG tubing, and combinations and variations thereof.

These and other objects, features and advantages will become apparent as reference is made to the following detailed description, preferred embodiments, and examples, given for the purpose of disclosure, and taken in conjunction with the accompanying drawings and appended claims.

### BRIEF DESCRIPTION OF THE DRAWINGS

For a further understanding of the nature and objects of the present invention, reference should be made to the following detailed disclosure, taken in conjunction with the accompanying drawings, in which like parts are given like reference numerals, and wherein:

FIG. 1A illustrates an upper, right perspective view of a standard lifting bail;

FIG. 1B illustrates a right perspective view of the standard lifting bail of FIG. 1A;

FIG. 2A illustrates a partial cross-sectional view of a double-shoulder connection with a pin and box made-up (screwed together), showing box connection features;

FIG. 2B illustrates the double-shoulder connection of FIG. 2A, showing pin connection features;

FIG. 3A illustrates a cross-sectional view of a rotating lifting bail with a slip clutch option according to an embodiment of the invention, showing a fixed position;

FIG. 3B illustrates the rotating lifting bail with the slip clutch option of FIG. 3A, showing a free position;

FIG. 4A illustrates a cross-sectional view of a rotating lifting bail with a square castellation slip clutch option according to an embodiment of the invention, showing a fixed position;

FIG. 4B illustrates the rotating lifting bail with the square castellation slip clutch option of FIGS. 4A, showing a free position;

FIG. 4C illustrates a partial cut-away view of an upper, left perspective view of a rotating lifting bail with a square castellation slip clutch option according to and embodiment of the invention; showing a fixed position;

FIG. 4D illustrates a partial cut-way view of an upper, right perspective view of the rotating lifting bail with the square castellation slip clutch option of FIG. 4C; showing a free position;

FIG. 5A illustrates a front, upper perspective view of a house castle ring and mandrel castle ring assembly for a rotating lifting bail with a tapered castellation slip clutch option according to an embodiment of the invention; showing a fixed position;

FIG. 5B illustrates the house castle ring and mandrel castle ring assembly for the rotating lifting bail with the tapered castellation slip clutch option; showing a free position;

FIG. 6A illustrates a cut-away view of a front, upper perspective view of a house castle ring and mandrel castle ring assembly for a rotating lifting bail with a rounded castellation slip clutch option, showing a fixed position;

FIG. 6B illustrates the house castle ring and mandrel castle ring assembly for the rotating lifting bail with the rounded castellation slip clutch option of FIG. 6A, showing a free position;

FIG. 7A illustrates a cross-sectional view of a rotating lifting bail with a manual option according to an embodiment of the invention; showing a fixed position;

FIG. 7B illustrates the rotating lifting bail with the manual option of FIG. 7A; showing a free position;

FIG. 8A illustrates a transverse cross-sectional view of a locking plate and rotating mandrel assembly for a rotating lifting bail with a two-flat manual option; showing a fixed position;

FIG. 8B illustrates the locking plate and rotating mandrel assembly for the rotating lifting bail with the two-flat manual option of FIG. 8A; showing a free position;

FIG. 9A illustrates a transverse cross-sectional view of a locking plate and rotating mandrel assembly for a rotating lifting bail with a hexagonal manual option; showing a fixed position;

FIG. 9B illustrates the locking plate and rotating mandrel assembly for the rotating lifting bail with the hexagonal manual option of FIG. 9A; showing a free position;

FIG. 10A illustrates a transverse cross-sectional view of a locking plate and rotating mandrel assembly for a rotating lifting bail with a tab manual option; showing a fixed position;

FIG. 10B illustrates the locking plate and rotating mandrel assembly for the rotating lifting bail with the tab manual option of FIG. 10A; showing a free position;

FIG. 11 illustrates a cross-sectional view of an interchangeable threaded connection according to an embodiment of the invention;

FIG. 12A illustrates a left perspective view of a hinged lifting bail, showing an extended position;

FIG. 12B illustrates the hinged lifting bail of FIG. 12A, showing a hinged position;

FIG. 13A illustrates a flowchart of a method of using a rotating lifting bail according to an embodiment of the invention;

FIG. 13B illustrates a flowchart of an additional step for the method of FIG. 13A;

FIG. 14A illustrates a flowchart of a method of using a rotating lifting bail having an interchangeable threaded connection according to an embodiment of the invention; and

FIG. 14B illustrates a flowchart of an additional step for the method of FIG. 14A.

### DETAILED DESCRIPTION OF EMBODIMENTS OF THE INVENTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

### Standard Lifting Bail

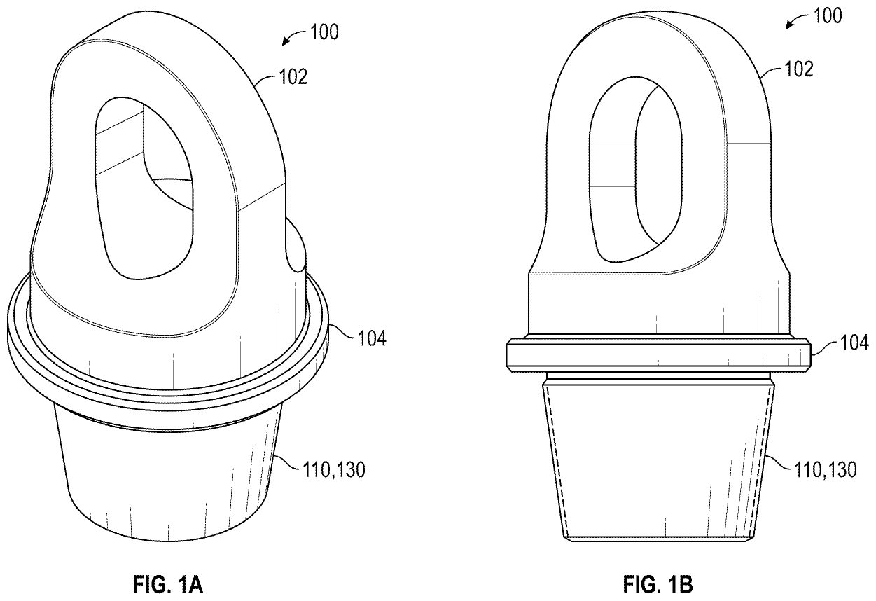

FIG. 1A illustrates an upper, right perspective view of a standard lifting bail; and FIG. 1B illustrates a right perspective view of the standard lifting bail of FIG. 1A.

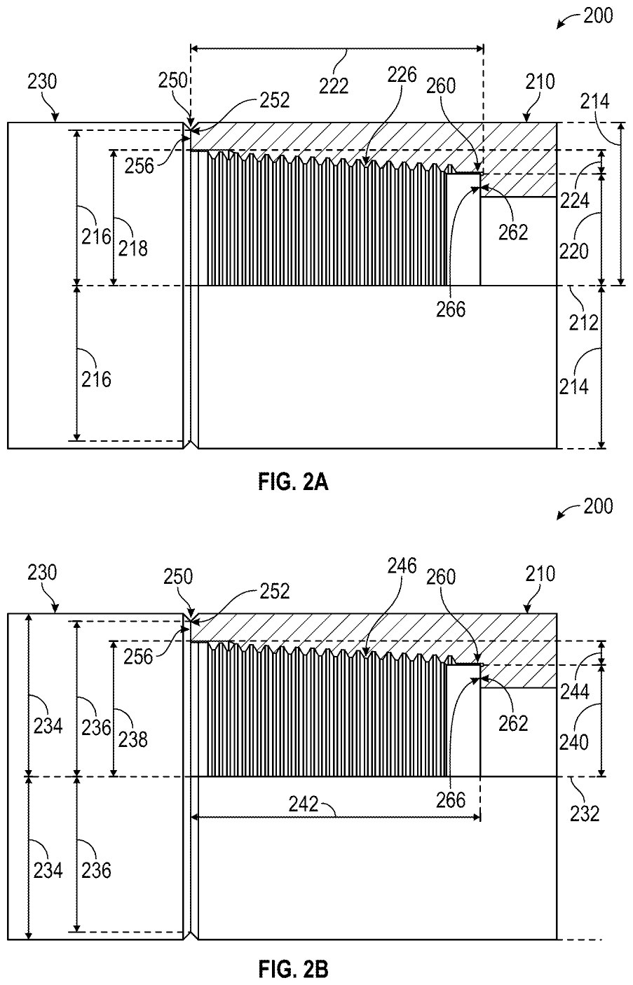

As shown in FIGS. 1A and 1B, a standard lifting bail 100 comprises a bail (i.e., loop) 102 at an upper end and a threaded connection 110, 130 (e.g., box connection 210, pin connection 230) at a lower end of the standard lifting bail 100. See FIGS. 2A & 2B.

The standard lifting bail 100 is typically made from a single piece of material. It is either machined from a single piece of bar stock, forging or casting. Due to their rigid, unitary structure, the bail (i.e., loop) 102 and the threaded connection 110, 130 of the standard lifting bail 100 cannot rotate with respect to each other.

The drilling tools that are lifted with lifting bails often need to be made-up with (i.e., screwed into) a second component. The second component is often unable to rotate. This requires rotating the component being lifted by the standard lifting bail 100.

As a result of their rigid, unitary structure, standard lifting bails 100 impart a twist into hoisting cables (i.e., wire rope) while making up the standard lifting bail 100 with the second component. This twisting can damage the hoisting cables due to being over-wound or under-wound, causing premature wear and tear on the hoisting cable. The premature wear and tear on the hoisting cable can cause premature failure, resulting in a safety hazard for personnel on the drilling rig floor.

To avoid potential premature failure, the useable life of the hoisting cable is often shortened.

Double-Shoulder Connection with Box and Pin Made-Up

FIG. 2A illustrates a partial cross-sectional view of a double-shoulder connection 200 with a pin and box made-up (screwed together), showing box connection 210 features; and FIG. 2B illustrates the double-shoulder connection 200 of FIG. 2A, showing pin connection 230 features. As shown in FIGS. 2A and 2B, the double-shoulder connection 200 comprises a box connection 210 having a box axis (centerline) 212, a pin connection 230 having a pin axis (centerline) 232, a primary shoulder 250 and a secondary shoulder 260.

In an embodiment, the box connection 210 comprises a box axis (centerline) 212, a box outer radius 214, a box bevel radius 216, a box counter bore radius 218, a box inner radius 220, a box depth 222, a box taper 224 and box threads 226 cut along the box taper 224. The box connection 210 is a female, internally threaded half of the double-shoulder connection 200, similar to a nut. See FIGS. 2A & 2B.

In an embodiment, the pin connection 230 comprises a pin axis (centerline) 232, a pin outer radius 234, a pin bevel radius 236, a pin cylinder radius 238, a pin nose radius 240, a pin length 242, a pin taper 244 and pin threads 246 cut along the pin taper 244. The pin connection 230 is a male, externally threaded half of the double-shoulder connection 200, similar to a bolt. See FIGS. 2A & 2B.

In an embodiment, any suitable connection box/pin taper 224, 244 may be used for the box/pin connection 200. For example, suitable connection box/pin taper 224, 244 may be from about % inch per foot to about 3 inches per foot, and any range or value there between.

### Rotating Lifting Bail

The present invention relates generally to a lifting and methods thereof and, more particularly, to an improved rotating lifting bail 300, 400, 700, 1100, 1200 and methods thereof. The rotating lifting bail 300, 400, 700, 1100, 1200 may be used in drill string (e.g., downhole, surface) for oil and gas applications (e.g., boring, drilling, exploration, plugging, production, remediation, workover). It may also be used for hoisting applications, water well operations and various other drilling applications.

### Slip Clutch Option

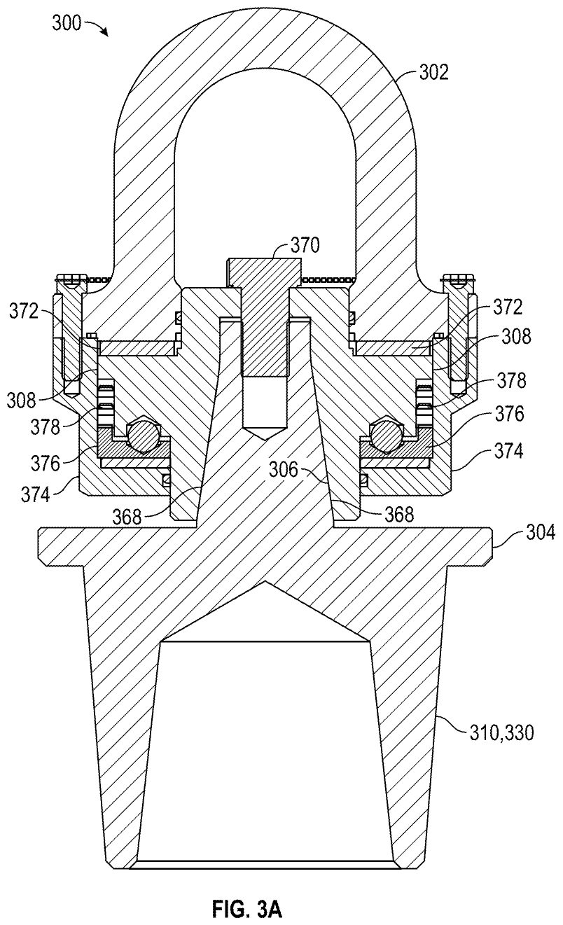

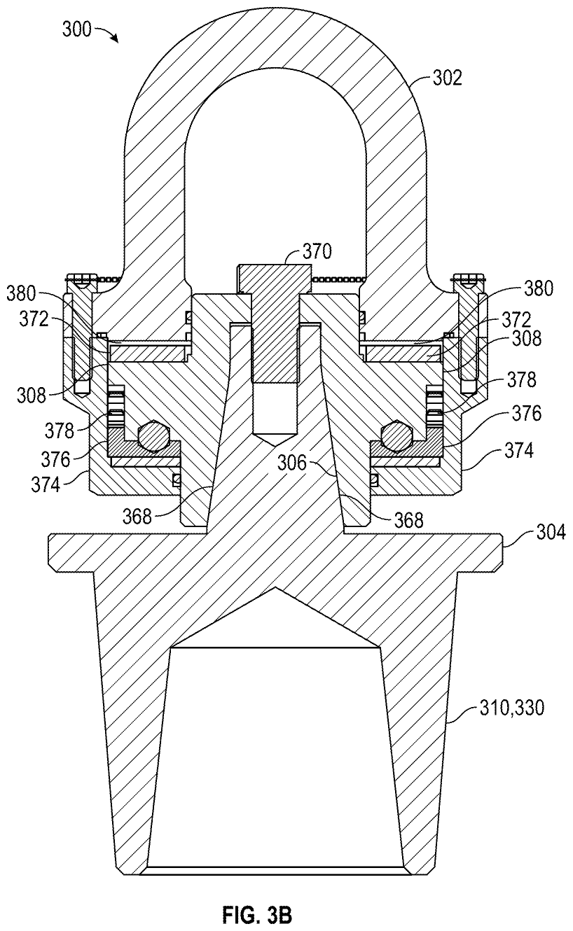

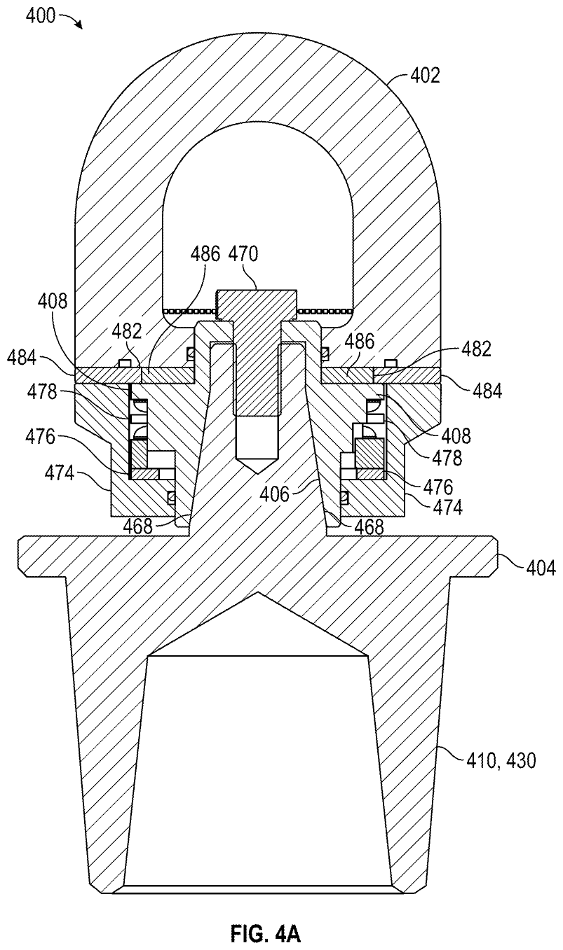

FIG. 3A illustrates a cross-sectional view of a rotating lifting bail 300 with a slip clutch option according to an embodiment of the invention, showing a fixed position; and FIG. 3B illustrates the rotating lifting bail 300 with the slip clutch option of FIG. 3A, showing a free position. As shown in FIGS. 3A and 3B, the rotating lifting bail 300 with the slip clutch option comprises a bail 302, a threaded connector 304, a rotating mandrel 308, and a jam bolt 370. In an embodiment, the threaded connector 304 has a tapered shaft 306 and a threaded connection 310, 330 (e.g., box connection 210, pin connection 230). See FIGS. 2A & 2B.

In an embodiment, the rotating mandrel 308 has a tapered bore 368 such that at least a portion of the tapered shaft 306 is disposed within the tapered bore 368. In an embodiment, the threaded connector 304 is connected to the rotating mandrel 308 via the jam bolt 370.

In an embodiment, a friction material 372 may be disposed between the bail 302 and the rotating mandrel 308. The friction material 372 may be any suitable friction material. For example, a suitable friction material 372 includes, but is not limited to, a high friction material, and a high friction material under spring pressure.

In an embodiment, a thrust bearing 376 is disposed between the rotating mandrel 308 and a housing 374.

In an embodiment, a spring 378 is disposed between the rotating mandrel 308 and the thrust bearing 376. The spring 378 may be any suitable spring.

In an embodiment, the rotating lifting bail 300, including any of its components, may be made of any suitable metal capable of lifting a product to be lifted. For example, suitable metals include, but are not limited to, aluminum alloys, cobalt alloys, copper alloys, low allow steel, stainless steel, super alloys, titanium alloys, and combinations and variations thereof. In an embodiment, the aluminum alloys include, but are not limited to, 2024 aluminum alloy, 6061 aluminum alloy, and 7075 aluminum alloy. In an embodiment, the cobalt alloys include, but are not limited to, Stellite. In an embodiment, the copper alloys include, but are not limited to, Beryllium Copper. In an embodiment, low alloy steel includes, but is not limited to, 4140 steel alloy, 4145 steel alloy, and 4330 steel alloy. In an embodiment, stainless steel includes, but is not limited to, 17-4 stainless steel alloy, 304 stainless steel alloy, and 316 stainless steel alloy. In an embodiment, super alloys include, but are not limited to Inconel. In an embodiment, titanium alloys include, but are not limited to Ti-6Al-4V titanium alloys, and Ti-6Al-6V-2Sn titanium alloys.

In an embodiment, the rotating lifting bail 300 with the slip clutch option uses a friction material 372 under spring pressure to resist rotation (i.e., fixed position) until an adequate amount of an axial lifting load is applied to overcome the spring pressure. See FIG. 3A

When the adequate amount of the axial lifting load is applied, the springs 374 are compressed. The compression of the springs results in relative axial motion between the bail 302 and the threaded connector 304 of the rotating lifting bail 300. This relative axial motion results in the disengagement of the friction material 372 from the bail 302, allowing relative rotational motion between the bail 302 and the threaded connector 304 of the rotating lifting bail 300 (i.e., free position). See FIG. 3B. The disengagement of the friction material 372 creates a gap 380 between the bail 302 and the friction material 372.

The relative rotation between the bail 302 and the threaded connector 304 is facilitated and supported by a thrust bearing 376.

The rotating lifting bail 300 with the slip clutch option can assist in properly torqueing the rotating lifting bail 300 to the component/product to be lifted. This would be based on the friction factors between the bail 302, the friction material 372, the rotating mandrel 308, and spring force. When a proper torque is reached, the bail 302 would rotate relative to the threaded connector 304.

When the axial lifting load is removed, the springs 374 are decompressed and relative rotational motion between the bail 302 and the threaded connector 304 of the rotating lifting bail 300 is restricted (i.e., fixed position). See FIG. 3A.

### Square Castellation Slip Clutch Option

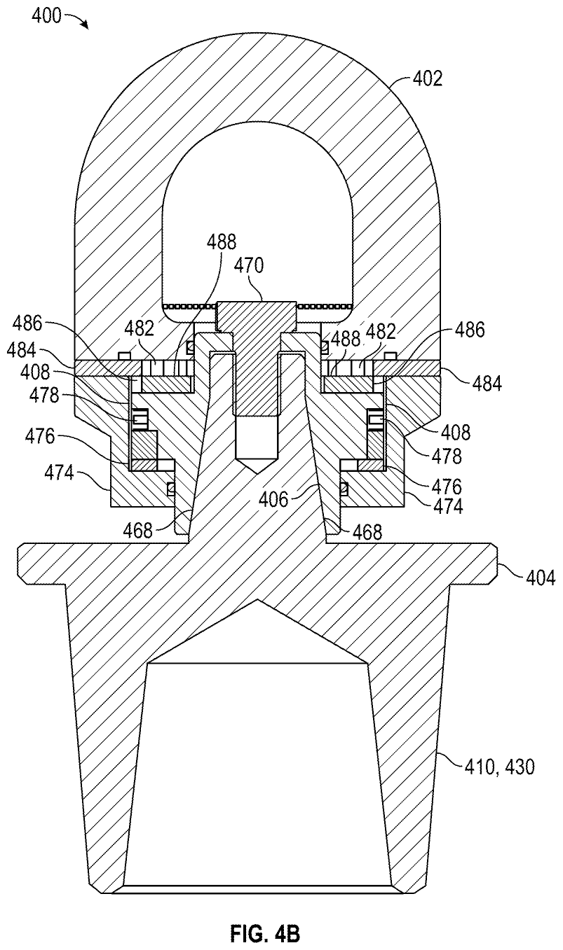

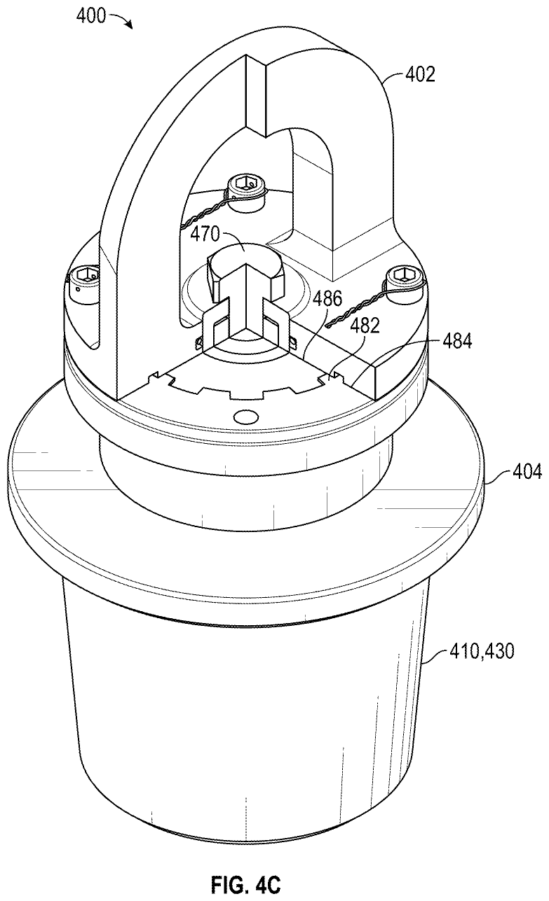

FIG. 4A illustrates a cross-sectional view of a rotating lifting bail 400 with a square castellation slip clutch option according to an embodiment of the invention, showing a fixed position; FIG. 4B illustrates the rotating lifting bail 400 with the square castellation slip clutch option of FIGS. 4A, showing a free position; FIG. 4C illustrates a partial cut-away view of an upper, left perspective view of a rotating lifting bail 400 with a square castellation slip clutch option according to and embodiment of the invention; showing a fixed position; and FIG. 4D illustrates a partial cut-way view of an upper, right perspective view of the rotating lifting bail 400 with the square castellation slip clutch option of FIG. 4C; showing a free position. As shown in FIGS. 4A-4D, the rotating lifting bail 400 with the slip clutch option comprises a bail 402, a threaded connector 404, a rotating mandrel 408, and a jam bolt 470. In an embodiment, the threaded connector 404 has a tapered shaft 406 and a threaded connection 410, 430 (e.g., box connection 210, pin connection 230). See FIGS. 2A & 2B.

In an embodiment, the rotating mandrel 408 has a tapered bore 468 such that at least a portion of the tapered shaft 406 is disposed within the tapered bore 468. In an embodiment, the threaded connector 404 is connected to the rotating mandrel 408 via the jam bolt 470.

In an embodiment, a housing castle ring 484 may be disposed between the bail 402 and a housing 474.

In an embodiment, a mandrel castle ring 486 may be disposed between the bail 402 and the rotating mandrel 408.

In an embodiment, the housing castle ring 484 and the mandrel castle ring 486 have castellations/interlocking teeth 482.

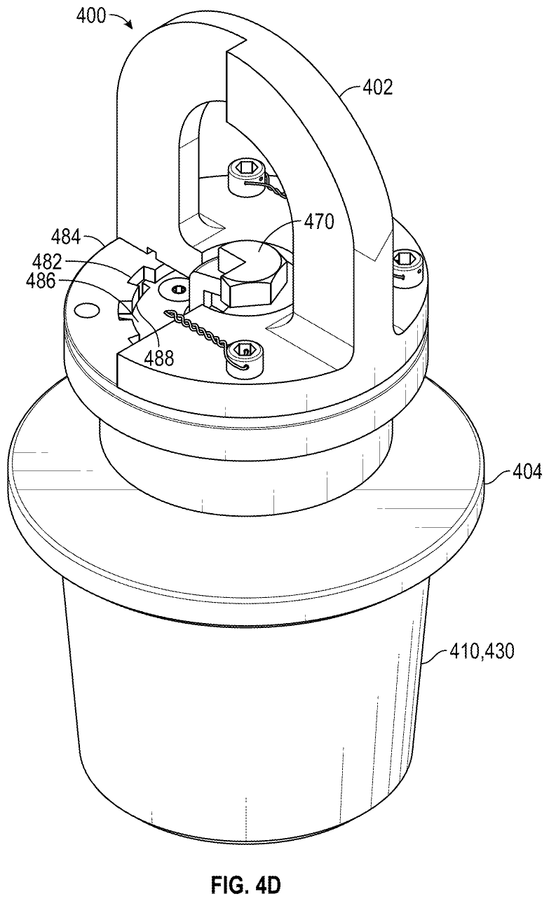

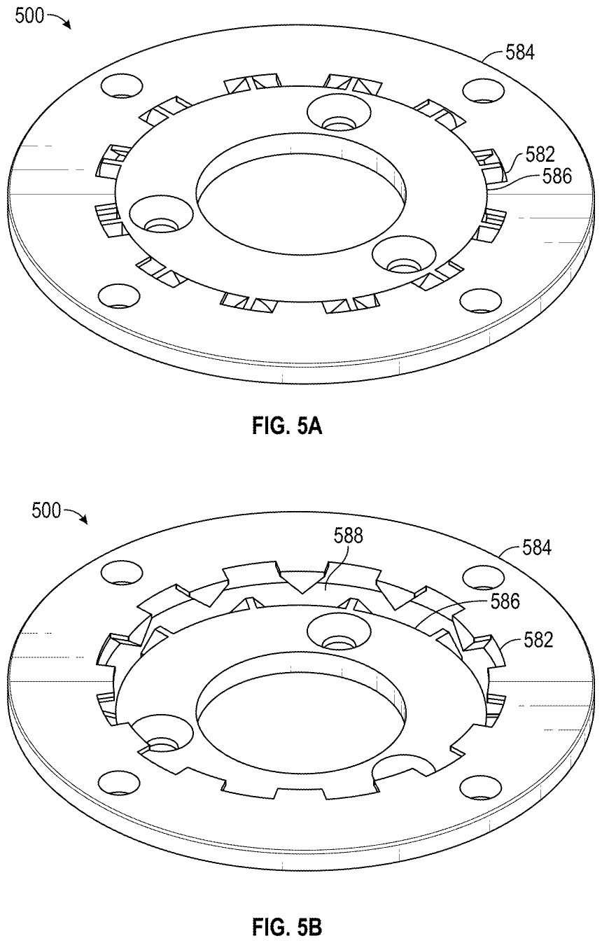

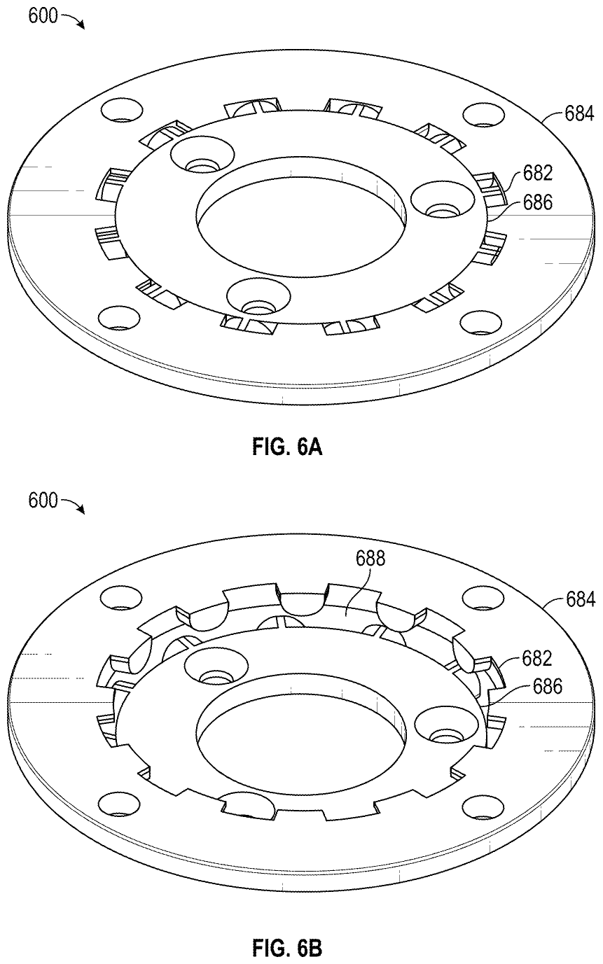

Any suitable castellations/interlocking teeth 482 may be used. For example, suitable castellations/interlocking teeth 482 include, but are not limited to, a square castellation that remains locked until an adequate axial lifting load is applied (see FIGS. 4A & 4B), a tapered castellation that remains locked until an adequate axial lifting load and/or rotational torque is applied (see FIGS. 5A & 5B), a rounded castellation that remains locked until an adequate axial lifting load and/or rotational torque is applied (see FIGS. 6A & 6B), the remainder of which are discussed below.

In some embodiments, the castellations/interlocking teeth 582, 682 have tapered or rounded sides. The tapered or rounded sides act as ramps such that, when adequate torque is applied (with or without an axial lifting load), the ramps on the castellations/interlocking teeth 582, 682 cause axial motion and pass over each other (i.e., free position). See FIGS. 5B & 6B. These tapered or rounded sides can also guide the castellations/interlocking teeth 582, 682 back into the fixed position when the axial lifting load is removed. See FIGS. 5A & 6A.

In an embodiment, a thrust bearing 476 is disposed between the rotating mandrel 408 and the housing 474.

In an embodiment, a spring 478 is disposed between the rotating mandrel 408 and the thrust bearing 476. The spring 478 may be any suitable spring.

In an embodiment, the rotating lifting bail 400, including any of its components, may be made of any suitable metal capable of lifting the component/product to be lifted. For example, suitable metals include, but are not limited to, aluminum alloys, cobalt alloys, copper alloys, low allow steel, stainless steel, super alloys, titanium alloys, and combinations and variations thereof. In an embodiment, the aluminum alloys include, but are not limited to, 2024 aluminum alloy, 6061 aluminum alloy, and 7075 aluminum alloy. In an embodiment, the cobalt alloys include, but are not limited to, Stellite. In an embodiment, the copper alloys include, but are not limited to, Beryllium Copper. In an embodiment, low alloy steel includes, but is not limited to, 4140 steel alloy, 4145 steel alloy, and 4330 steel alloy. In an embodiment, stainless steel includes, but is not limited to, 17-4 stainless steel alloy, 304 stainless steel alloy, and 316 stainless steel alloy. In an embodiment, super alloys include, but are not limited to Inconel. In an embodiment, titanium alloys include, but are not limited to Ti-6Al-4V titanium alloys, and Ti-6Al-6V-2Sn titanium alloys.

The rotating lifting bail 400 with the square castellation slip clutch option uses castellations/interlocking teeth 482 held in the engaged position (i.e., fixed position) by spring pressure to resist rotation until an adequate amount of an axial lifting load is applied to overcome the spring pressure. See FIG. 4A.

When the adequate amount of the axial lifting load is applied, the springs 474 are compressed. The compression of the springs results in relative axial motion between the bail 402 and the threaded connector 404 of the rotating lifting bail 400. This relative axial motion results in the disengagement of the castellations/interlocking teeth 482 (i.e., housing castle ring 484 and mandrel castle ring 486), allowing relative rotational motion between the bail 402 and the threaded connector 404 of the rotating lifting bail 400 (free position). See FIG. 4B. The disengagement of the castellation/interlocking teeth 482 creates a gap 488 between the bail 402 and the mandrel castle ring 486.

The relative rotation between the bail 402 and the threaded connector 404 is facilitated and supported by a thrust bearing 476.

When the axial lifting load is removed, the springs 478 are decompressed and relative rotational motion between the bail 402 and the threaded connector 404 of the rotating lifting bail 400 is restricted (i.e., fixed position). See FIG. 4A.

### Tapered Castellation Slip Clutch Option

FIG. 5A illustrates a front, upper perspective view of a housing castle ring 484, 584 and a mandrel castle ring 486, 586 assembly for a rotating lifting bail 400, 500 with a tapered castellation slip clutch option according to an embodiment of the invention; showing a fixed position; and FIG. 5B illustrates the housing castle ring 484, 584 and mandrel castle ring 486, 586 assembly for the rotating lifting bail with the tapered castellation slip clutch option; showing a free position. See FIGS. 4A-4D. As shown in FIGS. 4A-4D, 5A and 5B, the rotating lifting bail 400, 500 with the slip clutch option comprises a bail 402, a threaded connector 404, a rotating mandrel 408, and a jam bolt 470. In an embodiment, the threaded connector 404 has a tapered shaft 406 and a threaded connection 410, 430 (e.g., box connection 210, pin connection 230). See FIGS. 2A & 2B.

In an embodiment, the rotating mandrel 408 has a tapered bore 468 such that at least a portion of the tapered shaft 406 is disposed within the tapered bore 468. In an embodiment, the threaded connector 404 is connected to the rotating mandrel 408 via the jam bolt 470.

In an embodiment, a housing castle ring 484, 584 may be disposed between the bail 402 and a housing 474.

In an embodiment, a mandrel castle ring 486, 586 may be disposed between the bail 402 and the rotating mandrel 408.

In an embodiment, the housing castle ring 484, 584 and the mandrel castle ring 486, 586 have castellations/interlocking teeth 482, 582.

Any suitable castellations/interlocking teeth 482, 582 may be used. For example, suitable castellations/interlocking teeth 482 include, but are not limited to, a square castellation that remains locked until an adequate axial lifting load is applied (see FIGS. 4A & 4B), a tapered castellation that remains locked until an adequate axial lifting load and/or rotational torque is applied (see FIGS. 5A & 5B), a rounded castellation that remains locked until an adequate axial lifting load and/or rotational torque is applied (see FIGS. 6A & 6B), the remainder of which are discussed below.

In some embodiments, the castellations/interlocking teeth 582, 682 have tapered or rounded sides. The tapered or rounded sides act as ramps such that, when adequate torque is applied (with or without an axial lifting load), the ramps on the castellations/interlocking teeth 582, 682 cause axial motion and pass over each other (i.e., free position). See FIGS. 5B & 6B. These tapered or rounded sides can also guide the castellations/interlocking teeth 582, 682 back into the fixed position when the axial lifting load is removed. See FIGS. 5A & 6A.

In an embodiment, a thrust bearing 476 is disposed between the rotating mandrel 408 and the housing 474.

In an embodiment, a spring 478 is disposed between the rotating mandrel 408 and the thrust bearing 476. The spring 478 may be any suitable spring.

In an embodiment, the rotating lifting bail 400, 500, including any of its components, may be made of any suitable metal capable of lifting the component/product to be lifted. For example, suitable metals include, but are not limited to, aluminum alloys, cobalt alloys, copper alloys, low allow steel, stainless steel, super alloys, titanium alloys, and combinations and variations thereof. In an embodiment, the aluminum alloys include, but are not limited to, 2024 aluminum alloy, 6061 aluminum alloy, and 7075 aluminum alloy. In an embodiment, the cobalt alloys include, but are not limited to, Stellite. In an embodiment, the copper alloys include, but are not limited to, Beryllium Copper. In an embodiment, low alloy steel includes, but is not limited to, 4140 steel alloy, 4145 steel alloy, and 4330 steel alloy. In an embodiment, stainless steel includes, but is not limited to, 17-4 stainless steel alloy, 304 stainless steel alloy, and 316 stainless steel alloy. In an embodiment, super alloys include, but are not limited to Inconel. In an embodiment, titanium alloys include, but are not limited to Ti-6Al-4V titanium alloys, and Ti-l6V-2Sn titanium alloys.

The rotating lifting bail 400, 500 with the tapered castellation slip clutch option uses castellations/interlocking teeth 482, 582 held in the engaged position (i.e., fixed position) by spring pressure to resist rotation until an adequate amount of an axial lifting load is applied to overcome the spring pressure. See FIGS. 4A & 5A.

When the adequate amount of the axial lifting load is applied, the springs 474 are compressed. The compression of the springs results in relative axial motion between the bail 402 and the threaded connector 404 of the rotating lifting bail 400, 500. This relative axial motion results in the disengagement of the castellations/interlocking teeth 482, 582 (i.e., housing castle ring 484, 584 and mandrel castle ring 486, 586), allowing relative rotational motion between the bail 402 and the threaded connector 404 of the rotating lifting bail 400, 500 (i.e., free position). See FIGS. 4B & 5B. The disengagement of the castellation/interlocking teeth 482, 582 creates a gap 488, 588 between the bail 402 and the mandrel castle ring 486, 586.

The relative rotation between the bail 402 and the threaded connector 404 is facilitated and supported by a thrust bearing 476.

When the axial lifting load is removed, the springs 478 are decompressed and relative rotational motion between the bail 402 and the threaded connector 404 of the rotating lifting bail 400, 500 is restricted (i.e., fixed position). See FIGS. 4A & 5A.

### Rounded Castellation Slip Clutch Option

FIG. 6A illustrates a cut-away view of a front, upper perspective view of a castle ring assembly for a rotating lifting bail with a rounded castellation slip clutch option, showing a free position; and FIG. 6B illustrates the castle ring assembly for the rotating lifting bail with the rounded castellation slip clutch option of FIG. 6A, showing a fixed position. As shown in FIGS. 4A-4D, 6A and 6B, the rotating lifting bail 400, 600 with the slip clutch option comprises a bail 402, a threaded connector 404, a rotating mandrel 408, and a jam bolt 470. In an embodiment, the threaded connector 404 has a tapered shaft 406 and a threaded connection 410, 430 (e.g., box connection 210, pin connection 230). See FIGS. 2A & 2B.

In an embodiment, the rotating mandrel 408 has a tapered bore 468 such that at least a portion of the tapered shaft 406 is disposed within the tapered bore 468. In an embodiment, the threaded connector 404 is connected to the rotating mandrel 408 via the jam bolt 470.

In an embodiment, a housing castle ring 484, 684 may be disposed between the bail 402 and a housing 474.

In an embodiment, a mandrel castle ring 486, 686 may be disposed between the bail 402 and the rotating mandrel 408.

In an embodiment, the housing castle ring 484, 684 and the mandrel castle ring 486, 686 have castellations/interlocking teeth 482, 682.

Any suitable castellations/interlocking teeth 482, 682 may be used. For example, suitable castellations/interlocking teeth 482, 682 include, but are not limited to, a square castellation that remains locked until an adequate axial lifting load is applied (see FIGS. 4A & 4B), a tapered castellation that remains locked until an adequate axial lifting load and/or rotational torque is applied (see FIGS. 5A & 5B), a rounded castellation that remains locked until an adequate axial lifting load and/or rotational torque is applied (see FIGS. 6A & 6B), the remainder of which are discussed below.

In some embodiments, the castellations/interlocking teeth 582, 682 have tapered or rounded sides. The tapered or rounded sides act as ramps such that, when adequate torque is applied (with or without an axial lifting load), the ramps on the castellations/interlocking teeth 582, 682 cause axial motion and pass over each other (i.e., free position). See FIGS. 5B & 6B. These tapered or rounded sides can also guide the castellations/interlocking teeth 582, 682 back into the fixed position when the axial lifting load is removed. See FIGS. 5A & 6A.

In an embodiment, a thrust bearing 476 is disposed between the rotating mandrel 408 and the housing 474.

In an embodiment, a spring 478 is disposed between the rotating mandrel 408 and the thrust bearing 476. The spring 478 may be any suitable spring.

In an embodiment, the rotating lifting bail 400, 600, including any of its components, may be made of any suitable metal capable of lifting the component/product to be lifted. For example, suitable metals include, but are not limited to, aluminum alloys, cobalt alloys, copper alloys, low allow steel, stainless steel, super alloys, titanium alloys, and combinations and variations thereof. In an embodiment, the aluminum alloys include, but are not limited to, 2024 aluminum alloy, 6061 aluminum alloy, and 7075 aluminum alloy. In an embodiment, the cobalt alloys include, but are not limited to, Stellite. In an embodiment, the copper alloys include, but are not limited to, Beryllium Copper. In an embodiment, low alloy steel includes, but is not limited to, 4140 steel alloy, 4145 steel alloy, and 4330 steel alloy. In an embodiment, stainless steel includes, but is not limited to, 17-4 stainless steel alloy, 304 stainless steel alloy, and 316 stainless steel alloy. In an embodiment, super alloys include, but are not limited to Inconel. In an embodiment, titanium alloys include, but are not limited to Ti-6Al-4V titanium alloys, and Ti-6Al-6V-25n titanium alloys.

The rotating lifting bail 400, 600 with the rounded castellation slip clutch option uses castellations/interlocking teeth 482, 682 held in the engaged position (i.e., fixed position) by spring pressure to resist rotation until an adequate amount of an axial lifting load is applied to overcome the spring pressure. See FIGS. 4A & 6A.

When the adequate amount of the axial lifting load is applied, the springs 474 are compressed. The compression of the springs results in relative axial motion between the bail 402 and the threaded connector 404 of the rotating lifting bail 400, 600. This relative axial motion results in the disengagement of the castellations/interlocking teeth 482, 682 (i.e., housing castle ring 484, 684 and mandrel castle ring 486, 686), allowing relative rotational motion between the bail 402 and the threaded connector 404 of the rotating lifting bail 400, 600 (free position). See FIGS. 4B & 6B. The disengagement of the castellation/interlocking teeth 482, 682 creates a gap 488, 688 between the bail 402 and the mandrel castle ring 486, 686.

The relative rotation between the bail 402 and the threaded connector 404 is facilitated and supported by a thrust bearing 476.

When the axial lifting load is removed, the springs 478 are decompressed and relative rotational motion between the bail 402 and the threaded connector 404 of the rotating lifting bail 400, 600 is restricted (i.e., fixed position). See FIGS. 4A & 6A.

### Manual Option

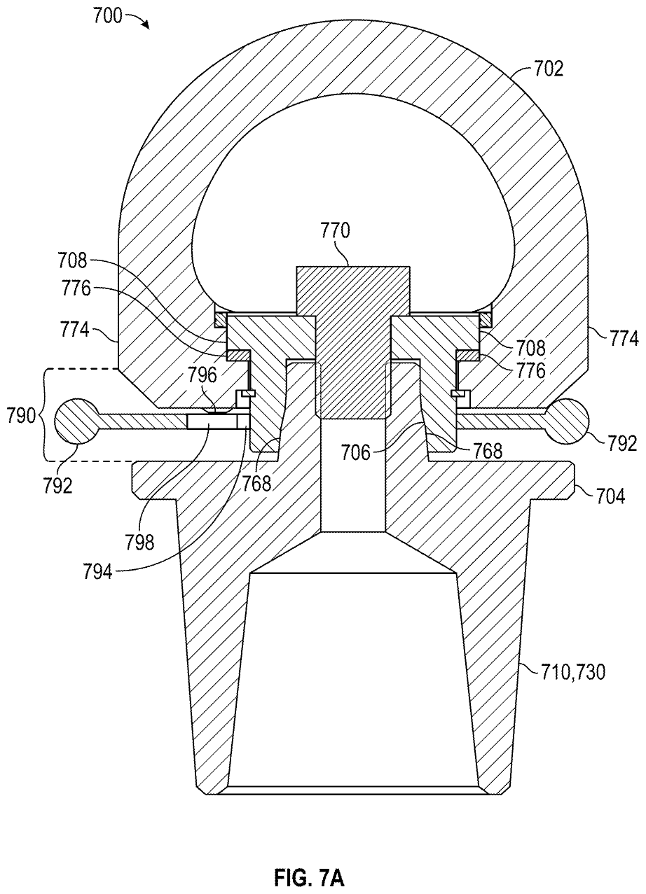

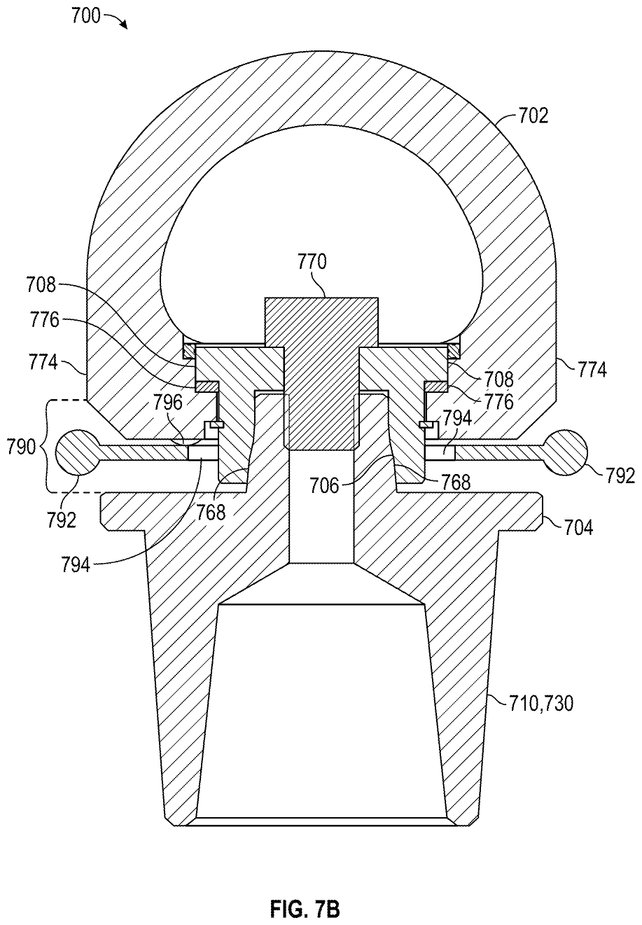

FIG. 7A illustrates a cross-sectional view of a rotating lifting bail 700 with a manual option according to an embodiment of the invention; showing a fixed position; and FIG. 7B illustrates the rotating lifting bail 700 with the manual option of FIG. 7A; showing a free position. As shown in FIGS. 7A and 7B, the rotating lifting bail 700 with the manual option comprises a bail 702, a threaded connector 704, a rotating mandrel 708, and a jam bolt 770. In an embodiment, the threaded connector 704 has a tapered shaft 706 and a threaded connection 710, 730 (e.g., box connection 210, pin connection 230). See FIGS. 2A & 2B.

In an embodiment, the rotating mandrel 708 has a tapered bore 768 such that at least a portion of the tapered shaft 706 is disposed within the tapered bore 768. In an embodiment, the threaded connector 704 is connected to the rotating mandrel 708 via the jam bolt 770.

In an embodiment, a locking plate 792 has an oversized bore 794 such that at least a portion of the rotating mandrel 708 is disposed inside the oversized bore 794.

In an embodiment, the locking plate 792 and the rotating mandrel 708 have a lock 790.

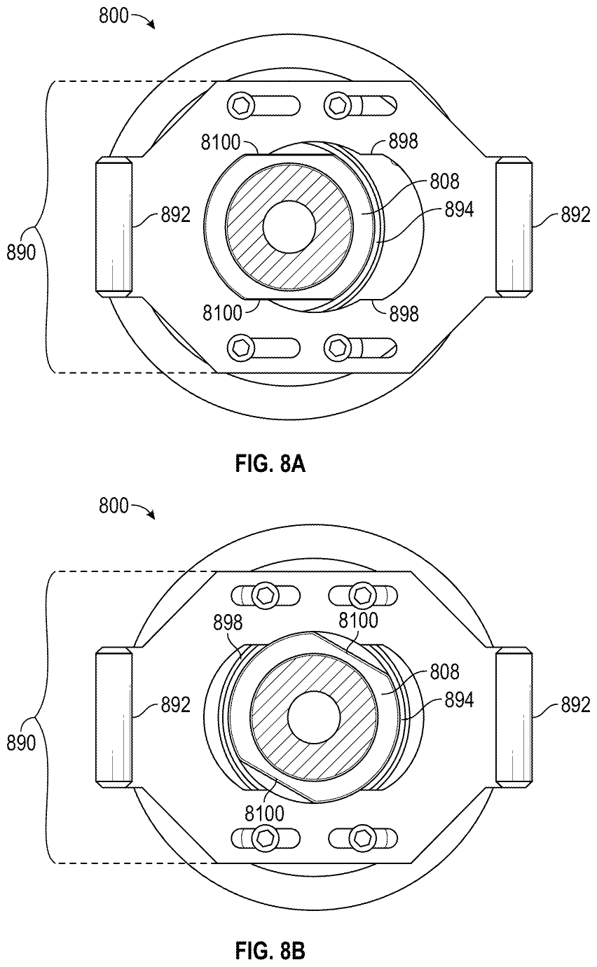

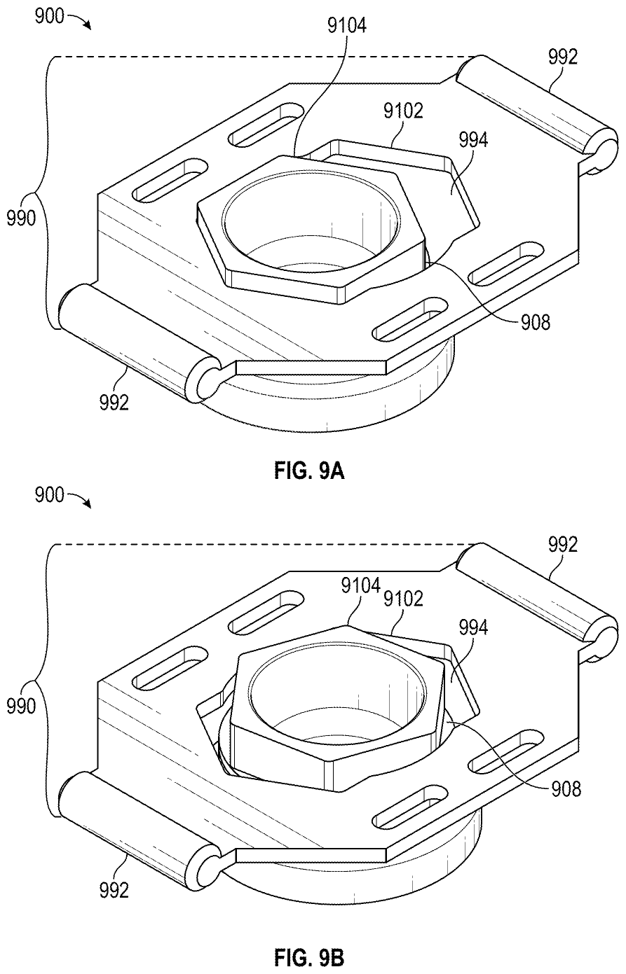

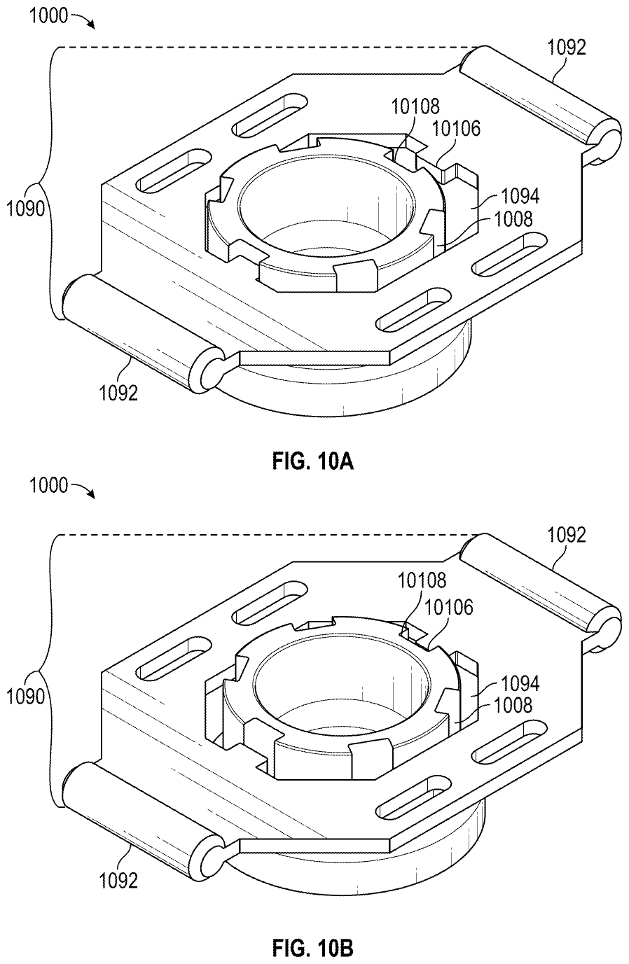

Any suitable lock 790 may be used. For example, suitable locks 790 include, but are not limited to, a wrench-style lock 790 on the locking plate (see FIGS. 7A & 7B), a two-flat slot-style lock 890 on the locking plate that matches machined surfaces on the rotating mandrel (see FIGS. 8A & 8B), a hexagonal slot-style lock 990 on the locking plate that matches machined surfaces on the rotating mandrel (see FIGS. 9A & 9B), and a tab-style lock 1090 that matches corresponding notches on the rotating mandrel (see FIGS. 10A & 10B), the remainder of which are discussed below.

In an embodiment, the rotating lifting bail 700, including any of its components, may be made of any suitable metal capable of lifting the component/product to be lifted. For example, suitable metals include, but are not limited to, aluminum alloys, cobalt alloys, copper alloys, low allow steel, stainless steel, super alloys, titanium alloys, and combinations and variations thereof. In an embodiment, the aluminum alloys include, but are not limited to, 2024 aluminum alloy, 6061 aluminum alloy, and 7075 aluminum alloy. In an embodiment, the cobalt alloys include, but are not limited to, Stellite. In an embodiment, the copper alloys include, but are not limited to, Beryllium Copper. In an embodiment, low alloy steel includes, but is not limited to, 4140 steel alloy, 4145 steel alloy, and 4330 steel alloy. In an embodiment, stainless steel includes, but is not limited to, 17-4 stainless steel alloy, 304 stainless steel alloy, and 316 stainless steel alloy. In an embodiment, super alloys include, but are not limited to Inconel. In an embodiment, titanium alloys include, but are not limited to Ti-6Al-4V titanium alloys, and Ti-6Al-6V-25n titanium alloys.

The locking plate 792 has a lock 790 that prevents the rotating mandrel 708 from rotating freely when the rotating lifting bail 700 is in the locked position (i.e., fixed position).

The rotating lifting bail 700 with a manual option uses the wrench-style lock 790 in a form of a detent 796 on a bottom surface of the bail 702 and a detent-resisted sliding locking plate 792 (motion transverse to the axis of the lifting bail 700) mounted to the bottom surface of the bail 702. The locking plate 792 moves between a locked position (i.e., fixed position) and a free rotation position (i.e., free position) as set by the operator.

The locking plate 792 has an oversized bore 794 that allows the rotating mandrel 708 to rotate freely when the rotating lifting bail 700 is in a free rotation position (i.e., free position).

Unlike the slip clutch option (see FIGS. 3A & 3B) and the castellation option (see FIGS. 4A-4D, 5A-5B & 6A-6B), the rotating lifting bail 700 with the manual option may be locked (i.e., fixed position) by the operator when the rotating lifting bail 700 is under an axial lifting load.

Further, the rotating lifting bail 700 with the manual option may be unlocked (i.e., free position) by the operator when the rotating lifting bail 700 is not under an axial lifting load.

The relative rotation between the bail 702 and the threaded connector 704 is facilitated and supported by a thrust bearing 776.

### Two-Flat Manual Option

FIG. 8A illustrates a transverse cross-sectional view of a locking plate 892 and rotating mandrel 808 assembly for a rotating lifting bail 800 with a two-flat manual option; showing a fixed position; and FIG. 8B illustrates the locking plate 892 and rotating mandrel 808 assembly for the rotating lifting bail 800 with the two-flat manual option of FIG. 8A; showing a free position. As shown in FIGS. 7A-7B and 8A-8B, the rotating lifting bail 700, 800 with the two-flat manual option comprises a bail 702, a threaded connector 704, a rotating mandrel 708, 808, and a jam bolt 770. In an embodiment, the threaded connector 704 has a tapered shaft 706 and a threaded connection 710, 730 (e.g., box connection 210, pin connection 230). See FIGS. 2A & 2B.

In an embodiment, the rotating mandrel 708, 808 has a tapered bore 768 such that at least a portion of the tapered shaft 706 is disposed within the tapered bore 768. In an embodiment, the threaded connector 704 is connected to the rotating mandrel 708, 808 via the jam bolt 770.

In an embodiment, a locking plate 792, 892 has an oversized bore 794, 894 such that at least a portion of the rotating mandrel 708, 808 is disposed inside the oversized bore 794, 894.

n an embodiment, the locking plate 792, 892 and the rotating mandrel 708, 808 have a lock 790, 890.

Any suitable lock 790, 809 may be used. For example, suitable locks 790, 890 include, but are not limited to, a wrench-style lock 790 on the locking plate (see FIGS. 7A & 7B), a two-flat slot-style lock 890 on the locking plate that matches machined surfaces on the rotating mandrel (see FIGS. 8A & 8B), a hexagonal slot-style lock 990 on the locking plate that matches machined surfaces on the rotating mandrel (see FIGS. 9A & 9B), and a tab-style lock 1090 on the locking plate that matches corresponding notches on the rotating mandrel (see FIGS. 10A & 10B), the remainder of which are discussed below.

In an embodiment, the rotating lifting bail 700, 800, including any of its components, may be made of any suitable metal capable of lifting the component/product to be lifted. For example, suitable metals include, but are not limited to, aluminum alloys, cobalt alloys, copper alloys, low allow steel, stainless steel, super alloys, titanium alloys, and combinations and variations thereof. In an embodiment, the aluminum alloys include, but are not limited to, 2024 aluminum alloy, 6061 aluminum alloy, and 7075 aluminum alloy. In an embodiment, the cobalt alloys include, but are not limited to, Stellite. In an embodiment, the copper alloys include, but are not limited to, Beryllium Copper. In an embodiment, low alloy steel includes, but is not limited to, 4140 steel alloy, 4145 steel alloy, and 4330 steel alloy. In an embodiment, stainless steel includes, but is not limited to, 17-4 stainless steel alloy, 304 stainless steel alloy, and 316 stainless steel alloy. In an embodiment, super alloys include, but are not limited to Inconel. In an embodiment, titanium alloys include, but are not limited to Ti-6A1-4V titanium alloys, and Ti-6A1-6V-25n titanium alloys.

The locking plate 792, 892 has a lock 790, 890 that prevents the rotating mandrel 708, 808 from rotating freely when the rotating lifting bail 700, 800 is in the locked position (i.e., fixed position).

The rotating lifting bail 800 with the two-flat manual option uses the two flat slot-style lock 890 in the form of a two flat slot 898 on the sliding locking plate 792, 892 (motion transverse to the axis of the lifting bail 700) mounted to a bottom surface of the bail 702 and matching machined surfaces 8100 on the rotating mandrel 708, 808. The locking plate 792, 892 moves between a locked position (i.e., fixed position) and a free rotation position (i.e., free position) as set by the operator.

The locking plate 792, 892 has an oversized bore 794, 894 that allows the rotating mandrel 708, 808 to rotate freely when the rotating lifting bail 700, 800 is in a free rotation position (i.e., free position).

Unlike the slip clutch option (see FIGS. 3A & 3B) and the castellation option (see FIGS. 4A-4D, 5A-5B & 6A-6B), the rotating lifting bail 700, 800 with the two flat manual option may be locked (i.e., fixed position) by the operator when the rotating lifting bail 700, 800 is under an axial lifting load.

Further, the rotating lifting bail 700, 800 with the two flat manual option may be unlocked (i.e., free position) by the operator when the rotating lifting bail 700, 800 is not under an axial lifting load.

The relative rotation between the bail 702 and the threaded connector 704 is facilitated and supported by a thrust bearing 776.

### Hexagonal Manual Option

FIG. 9A illustrates a transverse cross-sectional view of a locking plate 992 and rotating mandrel 908 assembly for a rotating lifting bail 900 with a hexagonal manual option; showing a fixed position; and FIG. 9B illustrates the locking plate 992 and rotating mandrel 908 assembly for the rotating lifting bail 900 with the hexagonal manual option of FIG. 9A; showing a free position. As shown in FIGS. 7A-7B and 9A-9B, the rotating lifting bail 700, 900 with the hexagonal manual option comprises a bail 702, a threaded connector 704, a rotating mandrel 708, 908, and a jam bolt 770. In an embodiment, the threaded connector 704 has a tapered shaft 706 and a threaded connection 710, 730 (e.g., box connection 210, pin connection 230). See FIGS. 2A & 2B.

In an embodiment, the rotating mandrel 708, 908 has a tapered bore 768 such that at least a portion of the tapered shaft 706 is disposed within the tapered bore 768. In an embodiment, the threaded connector 704 is connected to the rotating mandrel 708, 908 via the jam bolt 770.

In an embodiment, a locking plate 792, 992 has an oversized bore 794, 994 such that at least a portion of the rotating mandrel 708, 908 is disposed inside the oversized bore 794, 994.

In an embodiment, the locking plate 792, 992 and the rotating mandrel 708, 908 have a lock 790, 990.

Any suitable lock 790, 990 may be used. For example, suitable locks 790, 990 include, but are not limited to, a wrench-style lock 790 on the locking plate (see FIGS. 7A & 7B), a two-flat slot-style lock 890 on the locking plate that matches machined surfaces on the rotating mandrel (see FIGS. 8A & 8B), a hexagonal slot-style lock 990 on the locking plate that matches machined surfaces on the rotating mandrel (see FIGS. 9A & 9B), and a tab-style lock 1090 on the locking plate that matches corresponding notches on the rotating mandrel (see FIGS. 10A & 10B), the remainder of which are discussed below.

In an embodiment, the rotating lifting bail 700, 900, including any of its components, may be made of any suitable metal capable of lifting the component/product to be lifted. For example, suitable metals include, but are not limited to, aluminum alloys, cobalt alloys, copper alloys, low allow steel, stainless steel, super alloys, titanium alloys, and combinations and variations thereof. In an embodiment, the aluminum alloys include, but are not limited to, 2024 aluminum alloy, 6061 aluminum alloy, and 7075 aluminum alloy. In an embodiment, the cobalt alloys include, but are not limited to, Stellite. In an embodiment, the copper alloys include, but are not limited to, Beryllium Copper. In an embodiment, low alloy steel includes, but is not limited to, 4140 steel alloy, 4145 steel alloy, and 4330 steel alloy. In an embodiment, stainless steel includes, but is not limited to, 17-4 stainless steel alloy, 304 stainless steel alloy, and 316 stainless steel alloy. In an embodiment, super alloys include, but are not limited to Inconel. In an embodiment, titanium alloys include, but are not limited to Ti-6Al-4V titanium alloys, and Ti-6Al-6V-2Sn titanium alloys.

The locking plate 792, 992 has a lock 790, 990 that prevents the rotating mandrel 708, 908 from rotating freely when the rotating lifting bail 700, 900 is in the locked position (i.e., fixed position).

The rotating lifting bail 900 with the hexagonal manual option uses a hexagonal slot-style lock 990 in the form of a hexagonal slot 9102 on the sliding locking plate 792, 992 (motion transverse to the axis of the lifting bail 700) mounted to a bottom surface of the bail 702 and matching machined surfaces 9104 on the rotating mandrel 708, 908. The locking plate 792, 992 moves between a locked position (i.e., fixed position) and a free rotation position (i.e., free position) as set by the operator.

The locking plate 792, 992 has an oversized bore 794, 994 that allows the rotating mandrel 708, 908 to rotate freely when the rotating lifting bail 700, 900 is in a free rotation position (i.e., free position).

Unlike the slip clutch option (see FIGS. 3A & 3B) and the castellation option (see FIGS. 4A-4D, 5A-5B & 6A-6B), the rotating lifting bail 700, 900 with the hexagonal manual option may be locked (i.e., fixed position) by the operator when the rotating lifting bail 700, 900 is under an axial lifting load.

Further, the rotating lifting bail 700, 900 with the hexagonal manual option may be unlocked (i.e., free position) by the operator when the rotating lifting bail 700, 900 is not under an axial lifting load.

The relative rotation between the bail 702 and the threaded connector 704 is facilitated and supported by a thrust bearing 776.

### Tab Manual Option

FIG. 10A illustrates a transverse cross-sectional view of a locking plate 792, 1092 and rotating mandrel 708, 1008 assembly for a rotating lifting bail 1000 with a tab manual option; showing a fixed position; and FIG. 10B illustrates the locking plate 792, 1092 and rotating mandrel 708, 1008 assembly for the rotating lifting bail 1000 with the tab manual option of FIG. 10A; showing a free position. As shown in FIGS. 7A-7B and 10A-10B, the rotating lifting bail 700, 1000 with the manual option comprises a bail 702, a threaded connector 704, a rotating mandrel 708, 1008, and a jam bolt 770. In an embodiment, the threaded connector 704 has a tapered shaft 706 and a threaded connection 710, 730 (e.g., box connection 210, pin connection 230). See FIGS. 2A & 2B.

In an embodiment, the rotating mandrel 708, 1008 has a tapered bore 768 such that at least a portion of the tapered shaft 706 is disposed within the tapered bore 768. In an embodiment, the threaded connector 704 is connected to the rotating mandrel 708, 1008 via the jam bolt 770.

In an embodiment, a locking plate 792, 1092 has an oversized bore 794, 1094 such that at least a portion of the rotating mandrel 708, 1008 is disposed inside the oversized bore 794, 1094.

In an embodiment, the locking plate 792, 1092 and the rotating mandrel 708, 1008 have a lock 790, 1090.

Any suitable lock 790, 1090 may be used. For example, suitable locks 790, 1090 include, but are not limited to, a wrench-style lock 790 on the locking plate (see FIGS. 7A & 7B), a two-flat slot-style lock 890 on the locking plate that matches machined surfaces on the rotating mandrel (see FIGS. 8A & 8B), a hexagonal slot-style lock 990 on the locking plate that matches machined surfaces on the rotating mandrel (see FIGS. 9A & 9B), and a tab-style lock 1090 on the locking plate that matches corresponding notches on the rotating mandrel (see FIGS. 10A & 10B), the remainder of which are discussed below.

In an embodiment, the rotating lifting bail 700, 1000, including any of its components, may be made of any suitable metal capable of lifting the component/product to be lifted. For example, suitable metals include, but are not limited to, aluminum alloys, cobalt alloys, copper alloys, low allow steel, stainless steel, super alloys, titanium alloys, and combinations and variations thereof. In an embodiment, the aluminum alloys include, but are not limited to, 2024 aluminum alloy, 6061 aluminum alloy, and 7075 aluminum alloy. In an embodiment, the cobalt alloys include, but are not limited to, Stellite. In an embodiment, the copper alloys include, but are not limited to, Beryllium Copper. In an embodiment, low alloy steel includes, but is not limited to, 4140 steel alloy, 4145 steel alloy, and 4330 steel alloy. In an embodiment, stainless steel includes, but is not limited to, 17-4 stainless steel alloy, 304 stainless steel alloy, and 316 stainless steel alloy. In an embodiment, super alloys include, but are not limited to Inconel. In an embodiment, titanium alloys include, but are not limited to Ti-6Al-4V titanium alloys, and Ti-6Al-6V-2Sn titanium alloys.

The locking plate 792, 1092 has a lock 790, 1090 that prevents the rotating mandrel 708, 1008 from rotating freely when the rotating lifting bail 700, 1000 is in the locked position (i.e., fixed position).

The rotating lifting bail 1000 with the tab manual option uses a tab-style lock 1090 in the form of a tab 10106 on the sliding locking plate 792, 1092 (motion transverse to the axis of the lifting bail 700) mounted to a bottom surface of the bail 702 and matching machined notch 10108 on the rotating mandrel 708, 1008. The locking plate 792, 1092 moves between a locked position (i.e., fixed position) and a free rotation position (i.e., free position) as set by the operator.

The locking plate 792, 1092 has an oversized bore 794, 1094 that allows the rotating mandrel 708, 1008 to rotate freely when the rotating lifting bail 700, 1000 is in a free rotation position (i.e., free position).

Unlike the slip clutch option (see FIGS. 3A & 3B) and the castellation option (see FIGS. 4A-4D, 5A-5B & 6A-6B), the rotating lifting bail 700, 1000 with the tab manual option may be locked (i.e., fixed position) by the operator when the rotating lifting bail 700, 1000 is under an axial lifting load.

Further, the rotating lifting bail 700, 1000 with the tap manual option may be unlocked (i.e., free position) by the operator when the rotating lifting bail 700, 1000 is not under an axial lifting load.

The relative rotation between the bail 702 and the threaded connector 704 is facilitated and supported by a thrust bearing 776.

### Interchangeable Threaded Connection

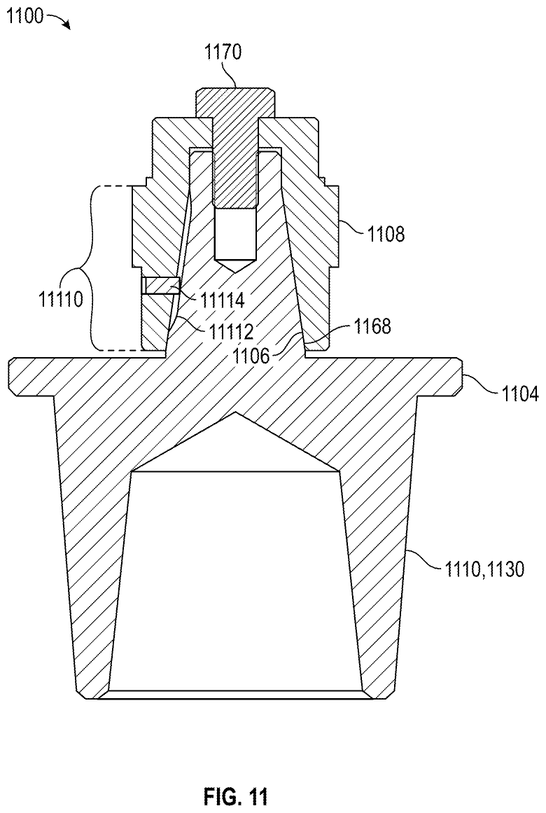

FIG. 11 illustrates a cross-sectional view of an interchangeable threaded connection 1100 according to an embodiment of the invention. As shown in FIG. 11, the interchangeable threaded connection 1100 comprises a threaded connector 1104, a rotating mandrel 1108, and a jam bolt 1170. In an embodiment, the threaded connector 1104 has a tapered shaft 1106 and a threaded connection 1110, 1130 (e.g., box connection 210, pin connection 230). See FIGS. 2A & 2B.

In an embodiment, the rotating mandrel 1108 has a tapered bore 1168 such that at least a portion of the tapered shaft 1106 is disposed within the tapered bore 1168. In an embodiment, the threaded connector 1104 is connected to the rotating mandrel 1108 via the jam bolt 1170.

In an embodiment, the tapered shaft 1106 and the rotating mandrel 1108 have a lock 11110.

Any suitable lock 11110 may be used. For example, suitable locks 11110 include, but are not limited to, a key-style lock 11110. See FIG. 11. In an embodiment, the lock 11110 has a keyway 11112 on the tapered shaft 1106 and a key 11114 disposed through the rotating mandrel 1108 to the keyway 11112 on the tapered shaft 1106.

The interchangeable threaded connection 1100, including any of its components, may be made of any suitable metal capable of lifting the component/product to be lifted. For example, suitable metals include, but are not limited to, aluminum alloys, cobalt alloys, copper alloys, low allow steel, stainless steel, super alloys, titanium alloys, and combinations and variations thereof. In an embodiment, the aluminum alloys include, but are not limited to, 2024aluminum alloy, 6061 aluminum alloy, and 7075 aluminum alloy. In an embodiment, the cobalt alloys include, but are not limited to, Stellite. In an embodiment, the copper alloys include, but are not limited to, Beryllium Copper. In an embodiment, low alloy steel includes, but is not limited to, 4140 steel alloy, 4145 steel alloy, and 4330 steel alloy. In an embodiment, stainless steel includes, but is not limited to, 17-4 stainless steel alloy, 304 stainless steel alloy, and 316 stainless steel alloy. In an embodiment, super alloys include, but are not limited to Inconel. In an embodiment, titanium alloys include, but are not limited to Ti-6Al-4V titanium alloys, and Ti-6Al-6V-2Sn titanium alloys.

The rotating lifting bail 300, 400, 700 may have an interchangeable threaded connection 1100. In an embodiment, the interchangeable threaded connection 1100 comprises a threaded connector 1104, a rotating mandrel 1108, and a jam bolt 1170. In an embodiment, the threaded connector 1104 has a tapered shaft 1106 and a threaded connection 1110, 1130 (e.g., box connection 210, pin connection 230). See FIGS. 2A & 2B.

As such, the interchangeable threaded connection 1100 allows a user to change the threaded connection type and size to use the rotating lifting bail 300, 400, 700 with drilling tools (e.g., component to be lifted) that have differing threaded connection types and sizes.

### Hinged Lifting Bail

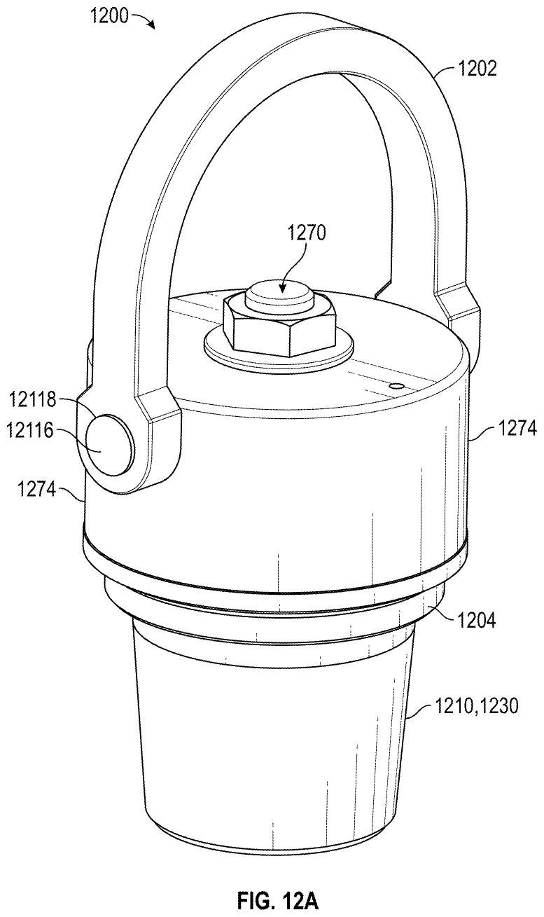

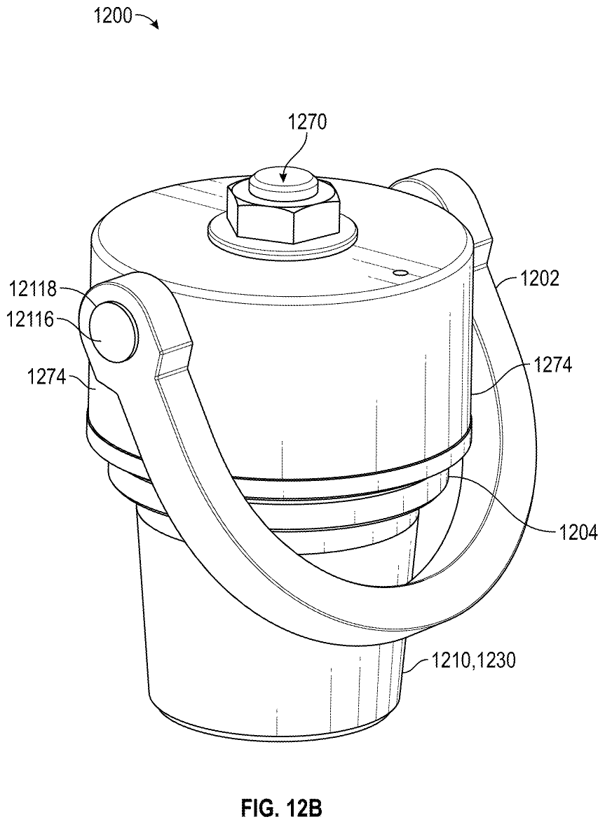

FIG. 12A illustrates a left perspective view of a hinged lifting bail 1200, showing an extended position; and FIG. 12B illustrates the hinged lifting bail 1200 of FIG. 12A, showing a hinged position. As shown in FIGS. 12A and 12B, the hinged lifting bail 1200 comprises a threaded connector 1204, a rotating mandrel (not shown), and a jam bolt 1270. In an embodiment, the threaded connector 1204 has a tapered shaft (not shown) and a threaded connection 1210, 1230 (e.g., box connection 210, pin connection 230). See FIGS. 2A & 2B.

In an embodiment, the bail 1202 may be rotatably attached to a housing 1274 via a hinge pin 12116.

In an embodiment, the bail 1202 has an opening 12118 that matches the hinge pin 12116.

In an embodiment, a first hinge pin 12116a is attached to the housing 1274 and a second hinge pin 12116b is attached to the housing 1274 opposite the first hinge pin 12116a.

In an embodiment, the first hinge pin 12116a is attached to the housing 1274 and the second hinge pin 12116b is attached to the housing 1274 opposite the first hinge pin 12116a at about 180 degrees.

The hinged lifting bail 1200, including any of its components, may be made of any suitable metal capable of lifting the component/product to be lifted. For example, suitable metals include, but are not limited to, aluminum alloys, cobalt alloys, copper alloys, low allow steel, stainless steel, super alloys, titanium alloys, and combinations and variations thereof. In an embodiment, the aluminum alloys include, but are not limited to, 2024 aluminum alloy, 6061 aluminum alloy, and 7075 aluminum alloy. In an embodiment, the cobalt alloys include, but are not limited to, Stellite. In an embodiment, the copper alloys include, but are not limited to, Beryllium Copper. In an embodiment, low alloy steel includes, but is not limited to, 4140 steel alloy, 4145 steel alloy, and 4330 steel alloy. In an embodiment, stainless steel includes, but is not limited to, 17-4 stainless steel alloy, 304 stainless steel alloy, and 316 stainless steel alloy. In an embodiment, super alloys include, but are not limited to Inconel. In an embodiment, titanium alloys include, but are not limited to Ti-6Al-4V titanium alloys, and Ti-6Al-6V-2Sn titanium alloys.

### Method of Using Rotating Lifting Bail

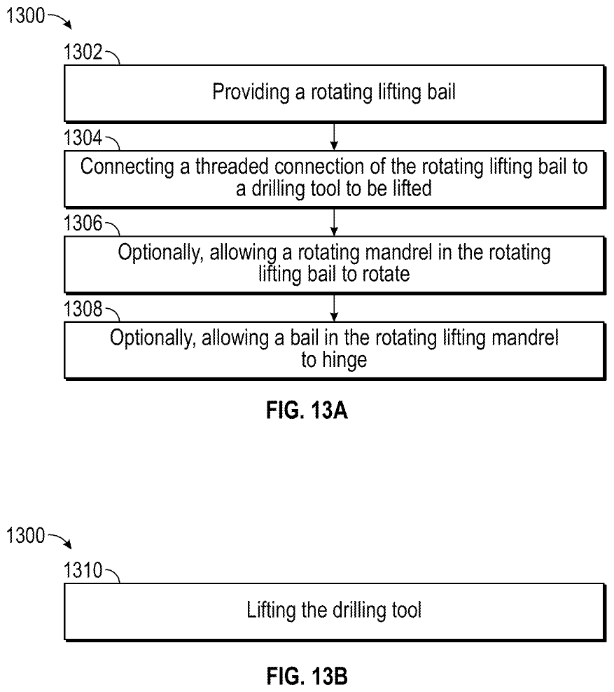

FIG. 13A illustrates a flowchart of a method of using a rotating lifting bail 1300 according to an embodiment of the invention; and FIG. 13B illustrates a flowchart of additional steps for the method 1300 of FIG. 13A

As shown in FIG. 13A, the method 1300 includes: providing a rotating lifting bail as discussed herein 1302; (b) connecting the threaded connection of the rotating lifting bail to a drilling tool to be lifted 1304; (c) optionally, allowing the rotating mandrel in the rotating lifting tool to rotate 1306; and (d) optionally, allowing the bail in the rotating lifting bail to hinge 1308.

As shown in FIG. 13B, the method further includes: (e) lifting the drilling tool 1310.

Method of using Rotating Lifting Bail having Interchangeable Treaded Connection

As discussed above, the interchangeable threaded connection 1100 allows a user to change the threaded connection type and size to use the rotating lifting bail 300, 400, 700 with drilling tools (e.g., component to be lifted) that have differing threaded connection types and sizes.

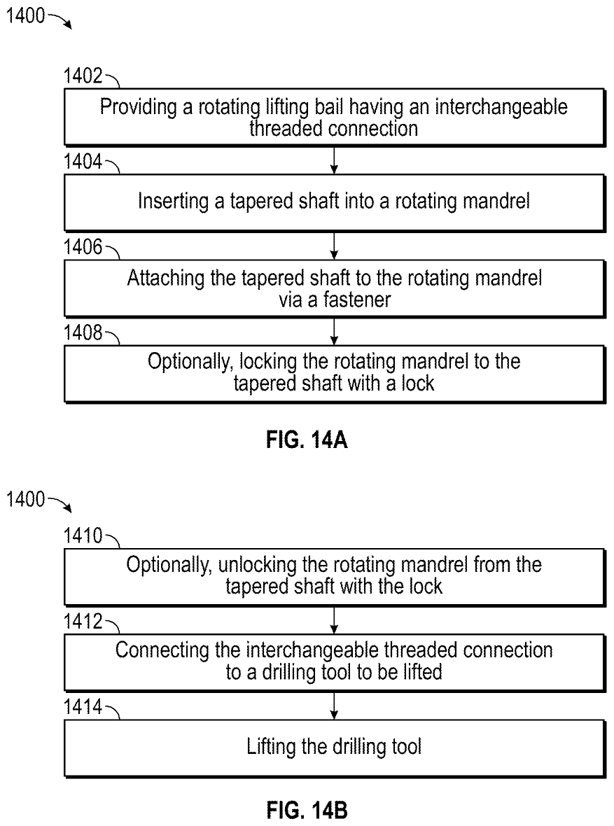

FIG. 14A illustrates a flowchart of a method of using a rotating lifting bail having an interchangeable threaded connection according to an embodiment of the invention; and FIG. 14B illustrates a flowchart of an additional step for the method of FIG. 14A.

As shown in FIG. 14A, the method 1400 includes: (a) providing a rotating lifting bail as discussed herein 1402, wherein the threaded connector is the interchangeable threaded connection; (b) inserting the tapered shaft into the rotating mandrel 1404; (c) attaching the tapered shaft to the rotating mandrel via the jam bolt 1406; and (d) optionally, locking the rotating mandrel to the tapered shaft with a lock 1408.

As shown in FIG. 14B, the method further includes: (e) optionally, unlocking the rotating mandrel from the tapered shaft with the lock 1410; and (f) connecting the interchangeable threaded connection to a drilling tool 1412.

In an embodiment, the method 1400 further includes: (g) lifting the drilling tool 1414.

### Suitable Drilling Tools (e.g., Components/Products to be Lifted)

The rotating lifting bail 300, 400, 700, interchangeable connector 1100, and hinged lifting 1200 may lift any suitable drilling tool (e.g., component/product to be lifted). For example suitable drilling tools (e.g., components/products to be lifted) include, but are not limited to, bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves UCTG casings, UCTG tubing, and well cleanout tools (e.g., brushes, magnets). In an embodiment, the drill pipe includes drill pipe having an outer diameter (OD) from about 2⅜-inch to about 7⅝-inch, and any range or value there between. In an embodiment, the heavy weight drill pipe includes heavy weight drill pipe having an outer diameter (OD) from about 2 ⅞-inch to about 6⅝-inch, and any range or value there between. In an embodiment, the drill collars include, but are not limited to, drill collars having an outer diameter (OD) from about 3 ⅛-inch to about 11-inch, and any range or value there between. In an embodiment, the pup joints include, but are not limited to, pup joints having an outer diameter (OD) from about 2⅜-inch to about 7⅝-inch, and any range or value there between.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms (e.g., “outer” and “inner,” “upper” and “lower,” “first” and “second,” “internal” and “external,” “above” and “below” and the like) are used as words of convenience to provide reference points and, as such, are not to be construed as limiting terms.

The embodiments set forth herein are presented to best explain the present invention and its practical application and to thereby enable those skilled in the art to make and utilize the invention. However, those skilled in the art will recognize that the foregoing description has been presented for the purpose of illustration and example only. The description as set forth is not intended to be exhaustive or to limit the invention to the precise form disclosed. Many modifications and variations are possible in light of the above teaching without departing from the spirit and scope of the following claims.

Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

Definitions

As used herein, the terms “a,” “an,” “the,” and “said” mean one or more, unless the context dictates otherwise.

As used herein, the term “about” means the stated value plus or minus a margin of error plus or minus 10% if no method of measurement is indicated.

As used herein, the term “or” means “and/or” unless explicitly indicated to refer to alternatives only or if the alternatives are mutually exclusive.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise,” provided above.

As used herein, the terms “having,” “has,” and “have” have the same open-ended meaning as “comprising,” “comprises,” and “comprise,” provided above.

As used herein, the terms “including,” “includes,” and “include” have the same open-ended meaning as “comprising,” “comprises,” and “comprise,” provided above.

As used herein, the phrase “consisting of” is a closed transition term used to transition from a subject recited before the term to one or more material elements recited after the term, where the material element or elements listed after the transition term are the only material elements that make up the subject.

As used herein, the phrase “material yields” means the material has exceeded its modulus of elasticity.

As used herein, the term “simultaneously” means occurring at the same time or about the same time, including concurrently.

As used herein, the term “detent” means a mechanism that prevents motion until released.

As used herein, the term “lifting bail” (also known as a “lifting cap”) means a short component that is temporarily connected to a top of a drill string elements (e.g., drill bits, drill collars, drill pipe, stabilizers, etc.) to be lifted vertically.

Incorporation By Reference. All patents and patent applications, articles, reports, and other documents cited herein are fully incorporated by reference to the extent they are not inconsistent with this invention.

What is claimed is:

1. A rotating lifting bail comprising:
(a) a bail;
(b) a threaded connector comprising a threaded connection;
(c) a rotating mandrel;
(d) a housing, wherein the bail is attached to the housing via a connector;
(e) a thrust bearing, wherein the thrust bearing is disposed between the rotating mandrel and the housing; and
(f) wherein the threaded connector is attached to the rotating mandrel via a jam bolt.

2. The rotating lifting bail of claim 1 further comprising a friction material, wherein the friction material is disposed between the bail and the rotating mandrel.

3. The rotating lifting bail of claim 1 further comprising a spring, wherein the spring is disposed between the thrust bearing and the rotating mandrel.

4. The rotating lifting bail of claim 1 further comprising:
(a) a friction material, wherein the friction material is disposed between the bail and the rotating mandrel; and
(b) a spring, wherein the spring is disposed between the thrust bearing and the rotating mandrel.

5. The rotating lifting bail of claim 1, wherein the threaded connector comprises a tapered shaft, wherein the rotating mandrel comprises a tapered bore and wherein at least a portion of the tapered shaft is disposed with at least a portion of the tapered bore.

6. The rotating lifting bail of claim 2 further comprising a gap between the bail and the friction material when an adequate axial lifting load is applied to the rotating lifting bail.

7. The rotating lifting bail of claim 4 further comprising a gap between the bail and the friction material when an adequate axial lifting load is applied to the rotating lifting bail.

8. The rotating lifting bail of claim 4, wherein the friction material is under spring pressure until an adequate axial lifting load is applied to the rotating lifting bail.

9. The rotating lifting bail of claim 1, wherein the threaded connector is an interchangeable connection.

10. The rotating lifting bail of claim 1, wherein the housing comprises a plurality hinge pins and wherein the bail comprises a plurality of openings that match the plurality of hinge pins, and wherein the bail is attached to the housing via the plurality of hinge pins.

11. The rotating lifting bail of claim 1, wherein the rotating lifting bail is made from one or more aluminum alloys, cobalt alloys, copper alloys, low allow steel, stainless steel, super alloys, titanium alloys, and combinations and variations thereof.

12. The rotating lifting bail of claim 1, wherein the rotating lifting bail is made from one or more of low alloy steels, stainless steels, and combinations and variations thereof.

13. The rotating lifting bail of claim 1, wherein the rotating lifting bail is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof.

14. The rotating lifting bail of claim 1, wherein the rotating lifting bail is connected to one or more of drill collars, drill pipe, heavy weight drill pipe, pup joints, and combinations and variations thereof.

15. A rotating lifting bail comprising:
(a) a bail;
(b) a threaded connector comprising a threaded connection;
(c) a rotating mandrel;
(d) a housing, wherein the bail is attached to the housing via a connector;
(e) a housing castle ring, wherein the housing castle ring is disposed between the bail and the housing;
(f) a mandrel castle ring, wherein the mandrel castle ring is disposed between the bail and the rotating mandrel and wherein the housing castle ring and the mandrel castle ring have interlocking teeth;
(g) a thrust bearing, wherein the thrust bearing is disposed between the rotating mandrel and the housing; and
(h) wherein the threaded connector is attached to the rotating mandrel via a jam bolt.

16. The rotating lifting bail of claim 15 further comprising a spring, wherein the spring is disposed between the thrust bearing and the rotating mandrel.

17. The rotating lifting bail of claim 15, wherein the threaded connector comprises a tapered shaft, wherein the rotating mandrel comprises a tapered bore and wherein at least a portion of the tapered shaft is disposed with at least a portion of the tapered bore.

18. The rotating lifting bail of claim 15, wherein the interlocking teeth are selected from the group consisting of a square castellation, a tapered castellation, a rounded castellation, and combinations thereof.

19. The rotating lifting bail of claim 18, wherein the interlocking teeth are a square castellation.

20. The rotating lifting bail of claim 18, wherein the interlocking teeth are a tapered castellation.

21. The rotating lifting bail of claim 18, wherein the interlocking teeth are a rounded castellation.

22. The rotating lifting bail of claim 15 further comprising a gap between the bail and the mandrel castle ring when an adequate axial lifting load is applied to the rotating lifting bail.

23. The rotating lifting bail of claim 15, wherein the housing castle ring and the mandrel castle ring are under spring pressure until an adequate axial lifting load is applied to the rotating lifting bail.

24. The rotating lifting bail of claim 15, wherein the interlocking teeth are under spring pressure until an adequate axial lifting load is applied to the rotating lifting bail.

25. The rotating lifting bail of claim 15, wherein the threaded connector is an interchangeable connection.

26. The rotating lifting bail of claim 15, wherein the housing comprises a plurality hinge pins and wherein the bail comprises a plurality of openings that match the plurality of hinge pins, and wherein the bail is attached to the housing via the plurality of hinge pins.

27. The rotating lifting bail of claim 15, wherein the rotating lifting bail is made from one or more aluminum alloys, cobalt alloys, copper alloys, low allow steel, stainless steel, super alloys, titanium alloys, and combinations and variations thereof.

28. The rotating lifting bail of claim 15, wherein the rotating lifting bail is made from one or more of low alloy steels, stainless steels, and combinations and variations thereof.

29. The rotating lifting bail of claim 15, wherein the rotating lifting bail is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof.

30. The rotating lifting bail of claim 15, wherein the rotating lifting bail is connected to one or more of drill collars, drill pipe, heavy weight drill pipe, pup joints, and combinations and variations thereof.

31. A rotating lifting bail comprising:
(a) a bail;
(b) a threaded connector comprising a threaded connection;
(c) a rotating mandrel;
(d) a locking plate comprising a bore and a lock wherein the locking plate is movably attached to the bail via a connector;
(e) a thrust bearing, wherein the thrust bearing is disposed between the rotating mandrel and the bail; and
(f) wherein the threaded connector is attached to the rotating mandrel via a jam bolt.

32. The rotating lifting bail of claim 31, wherein the threaded connector comprises a tapered shaft, wherein the rotating mandrel comprises a tapered bore and wherein at least a portion of the tapered shaft is disposed with at least a portion of the tapered bore.

33. The rotating lifting bail of claim 31, wherein the lock is selected from the group consisting of a wrench-style lock on the locking plate, a two-flat slot-style lock on the locking plate that matches machined surfaces on the rotating mandrel, a hexagonal-style lock on the locking plate that matches machined surfaces on the rotating mandrel, a tab-style lock on the locking plate that matches machined surfaces on the rotating mandrel, and combinations thereof.

34. The rotating lifting bail of claim 31, wherein the lock is a wrench-style lock.

35. The rotating lifting bail of claim 31, wherein the lock is a two-flat slot-style lock.

36. The rotating lifting bail of claim 31, wherein the lock is a hexagonal-style lock.

37. The rotating lifting bail of claim 31, wherein the lock is a tab-style lock.

38. The rotating lifting bail of claim 31 further comprising a detent attached to a bottom surface of the bail, wherein the detent is disposed between the bail and the locking plate.

39. The rotating lifting bail of claim 31, wherein the threaded connector is an interchangeable connection.

40. The rotating lifting bail of claim 31, wherein the housing comprises a plurality hinge pins and wherein the bail comprises a plurality of openings that match the plurality of hinge pins, and wherein the bail is attached to the housing via the plurality of hinge pins.

41. The rotating lifting bail of claim 31, wherein the rotating lifting bail is made from one or more aluminum alloys, cobalt alloys, copper alloys, low allow steel, stainless steel, super alloys, titanium alloys, and combinations and variations thereof.

42. The rotating lifting bail of claim 31, wherein the rotating lifting bail is made from one or more of low alloy steels, stainless steels, and combinations and variations thereof.

43. The rotating lifting bail of claim 31, wherein the rotating lifting bail is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof.

44. The rotating lifting bail of claim 31, wherein the rotating lifting bail is connected to one or more of drill collars, drill pipe, heavy weight drill pipe, pup joints, and combinations and variations thereof.

45. A method of using a rotating lifting bail, the method comprising:
(a) providing the rotating lifting bail of claim 1;
(b) connecting the threaded connection of the rotating lifting bail to a drilling tool to be lifted;
(c) optionally, allowing the rotating mandrel in the rotating lifting bail to rotate; and
(d) optionally, allowing the bail in the rotating lifting bail to hinge.

46. The method of claim 45 further comprising:
(e) lifting the drilling tool.

47. The rotating lifting bail of claim 45, wherein the rotating lifting bail is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof.

48. The method of claim 45, wherein the rotating lifting bail is connected to one or more of drill collars, drill pipe, heavy weight drill pipe, pup joints, and combinations and variations thereof.

49. A method of using a rotating lifting bail, the method comprising:
(a) providing the rotating lifting bail of claim 15;
(b) connecting the threaded connection of the rotating lifting bail to a drilling tool to be lifted;
(c) optionally, allowing the rotating mandrel in the rotating lifting bail to rotate; and
(d) optionally, allowing the bail in the rotating lifting bail to hinge.

50. The method of claim 49 further comprising:
(e) lifting the drilling tool.

51. The rotating lifting bail of claim 49, wherein the rotating lifting bail is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof.

52. The method of claim 49, wherein the rotating lifting bail is connected to one or more of drill collars, drill pipe, heavy weight drill pipe, pup joints, and combinations and variations thereof.

53. A method of using a rotating lifting bail, the method comprising:
(a) providing the rotating lifting bail of claim 31;
(b) connecting the threaded connection of the rotating lifting bail to a drilling tool to be lifted;
(c) optionally, allowing the rotating mandrel in the rotating lifting tool to rotate; and
(d) optionally, allowing the bail in the rotating lifting bail to hinge.

54. The method of claim 52 further comprising:
(e) lifting the drilling tool.

55. The rotating lifting bail of claim 53, wherein the rotating lifting bail is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof.

56. The method of claim 53, wherein the rotating lifting bail is connected to one or more of drill collars, drill pipe, heavy weight drill pipe, pup joints, and combinations and variations thereof.

57. A method of using a rotating lifting bail having an interchangeable threaded connection, the method comprising:
(a) providing a rotating lifting bail of claim 1, wherein the threaded connector is the interchangeable threaded connection;
(b) inserting the tapered shaft into the rotating mandrel;
(c) attaching the tapered shaft to the rotating mandrel via the jam bolt; and
(d) optionally, locking the rotating mandrel to the tapered shaft with a lock.

58. The method of claim 57, wherein the lock comprises a keyway in the tapered shaft and a key disposed through the rotating mandrel into the keyway in the tapered shaft.

59. The method of claim 57 further comprising:
(e) optionally, unlocking the rotating mandrel from the tapered shaft with the lock;
(f) connecting the interchangeable threaded connection to a drilling tool to be lifted; and
(g) lifting the drilling tool.

60. The method of claim 57, wherein the interchangeable threaded connection is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof.

61. The method of claim 57, wherein the interchangeable threaded connection is connected to one or more of drill collars, drill pipe, heavy weight drill pipe, pup joints, and combinations and variations thereof.

62. A method of using a rotating lifting bail having an interchangeable threaded connection, the method comprising:
(a) providing a rotating lifting bail of claim 15, wherein the threaded connector is the interchangeable threaded connection;
(b) inserting the tapered shaft into the rotating mandrel;
(c) attaching the tapered shaft to the rotating mandrel via the jam bolt; and
(d) optionally, locking the rotating mandrel to the tapered shaft with a lock.

63. The method of claim 62, wherein the lock comprises a keyway in the tapered shaft and a key disposed through the rotating mandrel into the keyway in the tapered shaft.

64. The method of claim 62 further comprising:
(e) optionally, unlocking the rotating mandrel from the tapered shaft with the lock;
(f) connecting the interchangeable threaded connection to a drilling tool to be lifted; and
(g) lifting the drilling tool.

65. The method of claim 62, wherein the interchangeable threaded connection is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof.

66. The method of claim 62, wherein the interchangeable threaded connection is connected to one or more of drill collars, drill pipe, heavy weight drill pipe, pup joints, and combinations and variations thereof.

67. A method of using a rotating lifting bail having an interchangeable threaded connection, the method comprising:
(a) providing a rotating lifting bail of claim 31, wherein the threaded connector is the interchangeable threaded connection;
(b) inserting the tapered shaft into the rotating mandrel;
(c) attaching the tapered shaft to the rotating mandrel via the jam bolt; and
(d) optionally, locking the rotating mandrel to the tapered shaft with a lock.

68. The method of claim 67, wherein the lock comprises a keyway in the tapered shaft and a key disposed through the rotating mandrel into the keyway in the tapered shaft.

69. The method of claim 67 further comprising:
(e) optionally, unlocking the rotating mandrel from the tapered shaft with the lock;
(f) connecting the interchangeable threaded connection to a drilling tool; and
(g) lifting the drilling tool.

70. The method of claim 67, wherein the interchangeable threaded connection is connected to one or more of bit subs, completion tools, crossover subs, directional drilling BHA components, drill bits, drill collars, drill pipe, float subs, fishing tools, heavy weight drill pipe, inside blowout preventers, Kelly valves, LWD components, MWD components, mud motors, pump-in subs, pup joints, rotary steerable tools, safety valves, saver subs, swivels, top drive shafts, top drive valves, UCTG casings, UCTG tubing, well cleanout tools, and combinations and variations thereof.

71. The method of claim 67, wherein the interchangeable threaded connection is connected to one or more of drill collars, drill pipe, heavy weight drill pipe, pup joints, and combinations and variations thereof.
